(19) United States
(12) Patent Application Publication
(10) Pub. No.: US 2019/0034061 A1
(43) Pub. Date: Jan. 31, 2019

(54) Object Processing Method And Terminal

(71) Applicant: HUAWEI TECHNOLOGIES CO., LTD., Shenzhen, Guangdong (CN)

(72) Inventor: Tao LIU, Wuhan (CN)

(21) Appl. No.: 16/083,558

(22) PCT Filed: Dec. 30, 2016
(86) PCT No.: PCT/CN2016/113986

§ 371 Date: Sep. 10, 2018

(30) Foreign Application Priority Data
Nov. 8, 2016 (CN) 201610980991.3

(51) Int. Cl. G06F 3/0484; G06F 3/0486; H04M 1/725

(52) U.S. Cl. CPC G06F 3/04842; H04M 1/72522; G06F 3/0486; G06F 3/04845

(57) ABSTRACT

The present disclosure relates to an object processing method. In one example method, a first display screen is displayed. The first display screen includes at least two objects. A first operation instruction is received. A selection mode is entered according to the operation instruction. A first selection instruction is received in the selection mode. A first position is determined according to the first selection instruction. A second selection instruction is received. A second position is determined according to the second selection instruction. An object between the first position and the second position is determined as a first target object.

### TECHNICAL FIELD

Embodiments of the present invention relate to the field of human-computer interaction, and more specifically, to an object processing method and terminal.

### BACKGROUND

Currently, based on a screen type of computer devices, the computer devices may be classified into non-touchscreen computer devices and touchscreen computer devices. Conventional non-touchscreen computer devices, such as PCs running Windows and Mac systems, may implement input by using a mouse. In an operation process of the conventional non-touchscreen computer devices, a plurality of icons, files, or folders on a screen need to be selected, a plurality of files or icons in a list need to be selected, or a plurality of objects in a folder need to be selected.

Description is provided by using an example in which the non-touchscreen computer device selects a file. When a file needs to be selected, it is only necessary to click a mouse. When a plurality of files need to be selected, a plurality of manners may be used for implementation. One manner is to draw a rectangular area by dragging a mouse to select files in the area. Another manner is to click the mouse to select one file, hold down a Shift key on a keyboard, and click the mouse to select the plurality of files, or move a focus by using a keyboard arrow key to select a file area between a first focus and a last focus. The foregoing selection manner is used to select files in a continuous area. Files in discontinuous areas can be selected by holding down a Ctrl key on the keyboard, and then clicking the mouse to select the files one by one or selecting the files by drawing rectangular areas by using the mouse. To select all files on the screen, the Ctrl key and a letter A key on the keyboard are held down simultaneously, to implement all-file selection. As the computer technologies develop rapidly, the computer devices provide a touchscreen function.

A manner of selecting a plurality of objects on the touchscreen computer device is usually tapping a button or a menu item on a touchscreen to enter a multi-selection mode, or long pressing an object to enter a multi-selection mode. A user may tap a “Select All” selection button in the multi-selection mode to select all files. In the multi-selection mode, the user may tap objects one by one to select the plurality of objects. An operation manner of selecting a plurality of pictures on a touchscreen device is described by using an example of a native Android system gallery Gallery 3D.

A user taps an icon on a touchscreen device screen to enter a gallery (pictures) application screen. The gallery application screen 10 may be shown in FIG. 1A. The gallery application screen 10 displays pictures in a gallery in a grid form. The gallery application screen 10 displays pictures 1 to 16. A menu option 11 is also displayed on the upper right of the gallery application screen 10. As shown in FIG. 1B, the user may tap the menu option 11 on the upper right of the gallery application screen 10, and submenus, selection entry 12 and grouping basis 13, pop out from the menu option 11. The user taps the selection entry 12 to enter a multi-selection mode. In the multi-selection mode, each picture tapping operation of the user is no longer a “View picture” operation but a “Select picture” operation. If the user taps any unselected picture, the picture will be selected. On the contrary, if the user taps any selected picture, the picture will be deselected. As shown in FIG. 1C, pictures 1 to 6 are selected. As shown in FIG. 1D, after selection is completed, a batch operation may be performed on the selected pictures 1 to 6. Tapping the menu option 11 in the upper right corner makes the following submenus pop up: delete 14, rotate left 15, and rotate right 16. The user may further tap a share option 17 to the left of the menu option 11, to share the selected pictures 1 to 6. The user may tap a “Return” option of the touchscreen device or a “Done” option in the upper left corner of the gallery application screen 10, to return to a view mode and exit the multi-selection mode.

In the foregoing operation manner, batch picture processing can be implemented by the user, a time is reduced to some extent compared with a single-picture operation, and discontinuous pictures can be selected. However, the foregoing operation manner also has disadvantages: Operation steps are complex and a selection process of tapping to select one by one is time-consuming. For example, in the multi-selection mode, the user needs to select three pictures with three taps and select 10 pictures with 10 taps. When there are a large quantity of pictures to be processed, for example, the user wants to delete first 200 pictures of 1000 pictures in the gallery, 200 taps need to be performed in the foregoing operation manner. As the quantity of pictures increases, complexity of a batch operation increases linearly and the operation becomes increasingly difficult.

### SUMMARY

Embodiments of the present invention provide an object processing method and terminal, to improve batch selection and processing efficiency of objects.

According to a first aspect, an embodiment of the present invention provides an object processing method. The method may be applied to a terminal. The terminal displays a first display screen, where the first display screen includes at least two objects. The terminal receives an operation instruction, and enters a selection mode according to the operation instruction. The terminal receives a first selection instruction in the selection mode, and determines a first position according to the first selection instruction. The terminal receives a second selection instruction, and determines a second position according to the second selection instruction. The terminal determines an object between the first position and the second position as a first target object. According to this technical solution, a target object is flexibly determined based on a position of a selection instruction. This increases convenience of batch selection for the terminal, and improves batch processing efficiency for the terminal.

With reference to the first aspect, in a first possible implementation of the first aspect, the terminal receives the first selection instruction on the first display screen, and determines the first position on the first display screen. Before the terminal receives the second selection instruction, the terminal receives a display screen switch operation instruction, and switches to a second display screen. The terminal receives the second selection instruction on the second display screen, and determines the second position on the second display screen. A display screen is switched, so that the terminal can perform a multi-selection operation on a plurality of display screens, and can select continuous objects at a time. This improves efficiency and convenience.

With reference to the first aspect or the first possible implementation of the first aspect, in a second possible implementation of the first aspect, the terminal receives a third selection instruction and a fourth selection instruction, determines a third position and a fourth position according to the third selection instruction and the fourth selection instruction, and determines an object between the third position and the fourth position as a second target object. The terminal marks both the first target object and the second target object as being in a selected state. According to this technical solution, a selection instruction can be input into the terminal for a plurality of times or a plurality of groups of selection instructions can be input into the terminal, to implement selection of a plurality of groups of target objects. This greatly improves multi-object batch processing efficiency.

With reference to the first aspect to the second possible implementation of the first aspect, in a third possible implementation of the first aspect, the terminal performs matching on the first selection instruction and a first preset instruction, and when the matching succeeds, determines that the first selection instruction is a selection instruction, and determines a position corresponding to the first selection instruction as the first position. The terminal performs matching on the second selection instruction and a second preset instruction, and when the matching succeeds, determines that the second selection instruction is a selection instruction, and determines a position corresponding to the second selection instruction as the second position. According to this technical solution, the terminal can preset a preset instruction, to implement rapid batch processing.

With reference to the second possible implementation of the first aspect, in a fourth possible implementation of the first aspect, the terminal performs matching on the third selection instruction and a first preset instruction, and when the matching succeeds, determines that the third selection instruction is a selection instruction, and determines a position corresponding to the third selection instruction as the third position. The terminal performs matching on the fourth selection instruction and a second preset instruction, and when the matching succeeds, determines that the fourth selection instruction is a selection instruction, and determines a position corresponding to the fourth selection instruction as the fourth position. According to this technical solution, the terminal can preset a preset instruction, to implement rapid batch processing.

With reference to the first aspect to the fourth possible implementation of the first aspect, in a fifth possible implementation of the first aspect, the first selection instruction may be a first track/gesture that is input by a user, and the second selection instruction is a second track/gesture that is input by the user. The first preset instruction is a first preset track/gesture, and the first preset instruction is a first preset track/gesture. The terminal performs matching on the first track/gesture and the first preset track/gesture, and when the matching succeeds, determines that the first track/gesture is a selection instruction, and determines a position corresponding to the first track/gesture as the first position. The terminal performs matching on the second track/gesture and the second preset track/gesture, and when the matching succeeds, determines that the second track/gesture is a selection instruction, and determines a position corresponding to the second track/gesture as the second position. A selection instruction is preset as a preset track/gesture, so that the terminal can rapidly determine whether an instruction that is input by the user matches a preset selection instruction. This improves processing efficiency of the terminal.

With reference to the first aspect to the fourth possible implementation of the first aspect, in a sixth possible implementation of the first aspect, the first selection instruction may be a first track/gesture that is input by a user, and the second selection instruction is a second track/gesture that is input by the user. The first preset instruction is a first preset character, and the first preset instruction is a first preset character. The terminal recognizes, based on the first track/gesture that is input by the user, the first track/gesture as a first character, performs matching on the first character and the first preset character, and when the matching succeeds, determines that the first character is a selection instruction, and determines a position corresponding to the first character as the first position. The terminal recognizes, based on the second track/gesture that is input by the user, the second track/gesture as a second character, performs matching on the second character and the second preset character, and when the matching succeeds, determines that the second character is a selection instruction, and determines a position corresponding to the second character as the second position. A selection instruction is preset as a preset character, to facilitate user input and terminal identification, so that the terminal can rapidly determine whether an instruction that is input by the user matches a preset selection instruction. This improves processing efficiency of the terminal.

With reference to the first aspect to the sixth possible implementation of the first aspect, in a seventh possible implementation of the first aspect, the terminal may further mark the target object as being in the selected state. Specifically, the terminal marks, according to the first selection instruction, an object after the first position as being selected, and then cancels selected-identification of an object outside the first position and the second position according to the second selection instruction. The terminal determines a selected target object in real time by detecting a selection instruction, and flexibly adjusts the selected target object. This simplifies complexity of multi-object processing by the terminal. The terminal presents a selection and processing process, further greatly improving interactivity of an interaction screen of the terminal.

With reference to the first aspect to the sixth possible implementation of the first aspect, in an eighth possible implementation of the first aspect, the terminal determines the object between the first position and the second position as the first target object by using a selected mode.

With reference to the eighth possible implementation of the first aspect, in a ninth possible implementation of the first aspect, the selected mode is at least one of the following modes: a horizontal selection mode, a longitudinal selection mode, a direction attribute mode, a unidirectional selection mode, or a closed image selection mode.

With reference to the first aspect to the ninth possible implementation of the first aspect, in a tenth possible implementation of the first aspect, the terminal determines a selection area based on the first position and the second position, and determines an object in the selection area as the first target object.

With reference to the first aspect to the tenth possible implementation of the first aspect, in an eleventh possible implementation of the first aspect, the first selection instruction is a start selection instruction, the first position is a start position, the second selection instruction is an end selection instruction, and the second position is an end position.

With reference to the first aspect to the eleventh possible implementation of the first aspect, in a twelfth possible implementation of the first aspect, the terminal displays a control screen of the selection mode, where the control screen is used to set the first preset instruction, and/or the second preset instruction, and/or the selected mode. A preset instruction is set, so that the terminal can flexibly configure the preset instruction. This improves object batch processing efficiency.

With reference to the twelfth possible implementation of the first aspect, in a thirteenth possible implementation of the first aspect, the control screen is used to set the first preset instruction as the first preset track/gesture/character; and/or the control screen is used to set the second preset instruction as the second preset track/gesture/character. A track/gesture/character is set as a preset instruction, to facilitate user input. This improves human-computer interaction efficiency of the terminal, and also increases a speed of internal batch processing of the terminal.

With reference to the first aspect to the thirteenth possible implementation of the first aspect, in a fourteenth possible implementation of the first aspect, the first operation instruction is a voice control instruction. The terminal enters the selection mode according to the voice control instruction. According to this technical solution, the terminal can receive a voice control instruction that is input by the user, to implement a control operation on the terminal, and implement object batch processing. This improves processing efficiency and interactivity of the terminal.

With reference to the first aspect to the fourteenth possible implementation of the first aspect, in a fifteenth possible implementation of the first aspect, the first selection instruction and/or the second selection instruction is a voice selection instruction. According to this technical solution, the terminal can receive a voice selection instruction that is input by the user, to implement batch object selection and processing. This improves processing efficiency and interactivity of the terminal.

According to a second aspect, an embodiment of the present invention provides an object processing terminal. The terminal includes a display unit, an input unit, and a processor. The display unit displays a first display screen including at least two objects. The input unit receives an operation instruction that is on the first display screen. The processor determines, according to the operation instruction, to enter a selection mode. In the selection mode, the input unit receives a first selection instruction and a second selection instruction. The processor determines a first position according to the first selection instruction, determines a second position according to the second selection instruction, and determines an object between the first position and the second position as a first target object. According to this technical solution, the terminal flexibly determines a target object based on a position of a selection instruction. This increases convenience of batch selection and improves batch processing efficiency.

With reference to the second aspect, in a second possible implementation of the second aspect, the input unit receives the first selection instruction on the first display screen. The processor determines the first position on the first display screen. The input unit receives a display screen switch operation instruction, where the display screen switch operation instruction is used to instruct to switch to a second display screen. The display unit displays the second display screen. The input unit receives the second selection instruction on the second display screen, and the processor determines the second position on the second display screen. A display screen is switched, so that the terminal can perform a multi-selection operation on a plurality of display screens, and can select continuous objects at a time. This improves efficiency and convenience.

With reference to the second aspect or the first possible implementation of the second aspect, in a second possible implementation of the second aspect, the input unit receives a third selection instruction and a fourth selection instruction; the processor determines a third position and a fourth position according to the third selection instruction and the fourth selection instruction, determines an object between the third position and the fourth position as a second target object, and marks both the first target object and the second target object as being in a selected state. According to this technical solution, a selection instruction can be input into the terminal for a plurality of times or a plurality of groups of selection instructions can be input into the terminal, to implement selection of a plurality of groups of target objects. This greatly improves multi-object batch processing efficiency.

With reference to the second aspect to the second possible implementation of the second aspect, in a third possible implementation of the second aspect, the processor performs matching on the first selection instruction and a first preset instruction, and when the matching succeeds, determines that the first selection instruction is a selection instruction, and determines a position corresponding to the first selection instruction as the first position. The processor performs matching on the second selection instruction and a second preset instruction, and when the matching succeeds, determines that the second selection instruction is a selection instruction, and determines a position corresponding to the second selection instruction as the second position. According to this technical solution, the terminal can preset a preset instruction, to implement rapid batch processing.

With reference to the second possible implementation of the first aspect, in a fourth possible implementation of the first aspect, the processor performs matching on the third selection instruction and a first preset instruction, and when the matching succeeds, determines that the third selection instruction is a selection instruction, and determines a position corresponding to the third selection instruction as the third position. The processor performs matching on the fourth selection instruction and a second preset instruction, and when the matching succeeds, determines that the fourth selection instruction is a selection instruction, and determines a position corresponding to the fourth selection instruction as the fourth position. According to this technical solution, the terminal can preset a preset instruction, to implement rapid batch processing.

With reference to the second aspect to the fourth possible implementation of the second aspect, in a fifth possible implementation of the second aspect, the first selection instruction is a first track/gesture, and the second selection instruction is a second track/gesture. The first preset instruction is a first preset track/gesture, and the first preset instruction is a first preset track/gesture. The processor performs matching on the first track/gesture and the first preset track/gesture, and when the matching succeeds, determines that the first track/gesture is a selection instruction, and determines a position corresponding to the first track/gesture as the first position. The processor performs matching on the second track/gesture and the second preset track/gesture, and when the matching succeeds, determines that the second track/gesture is a selection instruction, and determines a position corresponding to the second track/gesture as the second position. A selection instruction is preset as a preset track/gesture, so that the terminal can rapidly determine whether an instruction that is input by a user matches a preset selection instruction. This improves processing efficiency of the terminal.

With reference to the second aspect to the fourth possible implementation of the second aspect, in a sixth possible implementation of the second aspect, the first selection instruction is a first track/gesture, and the second selection instruction is a second track/gesture. The first preset instruction is a first preset character, and the second preset instruction is a second preset character. The processor recognizes the first track/gesture as a first character, performs matching on the first character and the first preset character, and when the matching succeeds, determines that the first character is a selection instruction, and determines a position corresponding to the first character as the first position. The processor recognizes the second track/gesture as a second character, performs matching on the second character and the second preset character, and when the matching succeeds, determines that the second character is a selection instruction, and determines a position corresponding to the second character as the second position. The terminal presets a selection instruction to a preset character, to facilitate user input and terminal identification, so that the terminal can rapidly determine whether an instruction that is input by a user matches a preset selection instruction. This improves processing efficiency of the terminal.

With reference to the second aspect to the sixth possible implementation of the second aspect, in a seventh possible implementation of the second aspect, the processor determines an object after the first position as being in the selected state according to the first selection instruction, and the display unit is further configured to display the selected state of the object after the first position. The terminal determines a selected target object in real time by detecting a selection instruction. The terminal presents a selection and processing process, further greatly improving interactivity of an interaction screen of the terminal.

With reference to the second aspect to the seventh possible implementation of the second aspect, in an eighth possible implementation of the second aspect, the display unit displays a control screen of the selection mode, where the control screen is used to set the first preset instruction, and/or the second preset instruction, and/or the selected mode. A preset instruction is set, so that the terminal can flexibly configure the preset instruction. This improves object batch processing efficiency.

With reference to the eighth possible implementation of the second aspect, in a ninth possible implementation of the second aspect, the input unit receives the first preset track/gesture/character and/or the second preset track/gesture/character that are input by the user. The processor determines that the first preset instruction is the first preset track/gesture/character; and/or determines that the second preset instruction is the second preset track/gesture/character. A track/gesture/character is set as a preset instruction, to facilitate user input. This improves human-computer interaction efficiency of the terminal, and also increases a speed of internal batch processing of the terminal.

With reference to the ninth possible implementation of the second aspect, in a tenth possible implementation of the first aspect, the terminal further includes a memory. The memory stores the first preset instruction as the first preset track/gesture/character, or the second preset instruction as the second preset track/gesture/character.

With reference to the second aspect to the tenth possible implementation of the second aspect, in an eleventh possible implementation of the second aspect, the processor determines the object between the first position and the second position as the target object by using the selected mode. The selected mode may be at least one of the following modes: a horizontal selection mode, a longitudinal selection mode, a direction attribute mode, a unidirectional selection mode, or a closed image selection mode.

With reference to the second aspect to the eleventh possible implementation of the second aspect, in a twelfth possible implementation of the second aspect, the input unit further includes a microphone, where the microphone receives the first selection instruction and/or the second selection instruction, and the first selection instruction and/or the second selection instruction is a voice selection instruction.

According to a third aspect, an embodiment of the present invention provides an object processing method. The method is applied to a terminal. The terminal displays a first display screen, where the first display screen includes at least two objects. The terminal receives an operation instruction, and enters a selection mode according to the operation instruction. In the selection mode, the terminal receives a first track/gesture/character. The terminal performs matching on the first track/gesture/character and a first preset track/gesture/character, and when the matching succeeds, determines that the first track/gesture/character is a selection instruction. The terminal determines a first position according to the first track/gesture/character. The terminal determines an object after the first position as a target object. According to this technical solution, a track/gesture/character is set as a preset selection instruction, and inputting one instruction can implement batch object selection. This significantly improves a processing capability and efficiency of the terminal.

According to a fourth aspect, an embodiment of the present invention provides an object processing terminal. The terminal includes a display unit, an input unit, and a processor. The display unit displays a first display screen including at least two objects. The input unit receives an operation instruction. The processor determines, according to the operation instruction, to enter a selection mode. In the selection mode, the input unit receives a first track/gesture/character. The processor performs matching on the first track/gesture/character and a first preset track/gesture/character, and when the matching succeeds, determines that the first track/gesture/character is a selection instruction, determines a first position according to the first track/gesture/character, and determines an object after the first position as a target object. According to this technical solution, a track/gesture/character is set as a preset selection instruction, and inputting one instruction can implement batch object selection. This significantly improves a processing capability and efficiency of the terminal.

According to the foregoing solutions, the terminal can flexibly detect a selection instruction that is input by the user, and determine a plurality of target objects according to the selection instruction. This improves batch object selection efficiency and increases a batch processing capability of the terminal.

### BRIEF DESCRIPTION OF DRAWINGS

FIG. 1A to FIG. 1D are schematic diagrams of implementing a multi-picture selection operation for a gallery application in the prior art;

FIG. 2 is a schematic structural diagram of a terminal according to an embodiment of the present invention;

FIG. 3A to FIG. 3G are schematic diagrams of implementing a multi-picture selection operation on a plurality of gallery application screens according to an embodiment of the present invention;

FIG. 4A to FIG. 4E are schematic diagrams of implementing a multi-object selection operation on a plurality of gallery application screens according to an embodiment of the present invention;

FIG. 5 is a schematic flowchart of implementing a multi-object selection operation method according to an embodiment of the present invention;

FIG. 6A to FIG. 6C are schematic diagrams of implementing a multi-object selection operation on a plurality of mobile phone display screens according to an embodiment of the present invention;

FIG. 7 is a schematic diagram of implementing a multi-object selection operation on a mobile phone display screen according to an embodiment of the present invention;

FIG. 8 is a schematic diagram of implementing a multi-object selection operation on a mobile phone display screen according to an embodiment of the present invention;

FIG. 9A to FIG. 9C are schematic diagrams of entering a selection mode by a mobile phone display screen in a plurality of manners according to an embodiment of the present invention;

FIG. 10 is a schematic diagram of implementing a multi-entry-object selection operation according to an embodiment of the present invention;

FIG. 11A to FIG. 11C are schematic diagrams of entering a selection mode control screen in a plurality of manners according to an embodiment of the present invention;

FIG. 12 is a schematic diagram of a selection mode control screen according to an embodiment of the present invention;

FIG. 13A to FIG. 13C are schematic diagrams of character option control screens according to an embodiment of the present invention;

FIG. 14A and FIG. 14B are schematic diagrams of track option control screens according to an embodiment of the present invention;

FIG. 15A and FIG. 15B are schematic diagrams of track option control screens according to an embodiment of the present invention; and

FIG. 16 is a schematic diagram of a selected-mode control screen according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

The terms used in the embodiments of the present invention are merely for the purpose of illustrating specific embodiments, and are not intended to limit the present invention. The terms “a”, “said” and “the” of singular forms used in the embodiments and the appended claims of the present invention are also intended to include plural forms, unless otherwise specified in the context clearly. It should also be understood that, the terms “and/or” and “or/and” used in this specification indicate and include any or all possible combinations of one or more associated listed items. The character “/” in this specification generally indicates an “or” relationship between the associated objects.

It should be understood that although in the embodiments of the present invention, terms first, second, third, fourth, and the like may be used to describe various display screens, positions, tracks, gestures, characters, preset instructions, selection instruction, and selection modes, these display screens, positions, tracks, gestures, characters, preset instructions, selection instructions, and selection modes should not be limited to these terms. These terms are merely used to differentiate between the display screens, the positions, the tracks, the gestures, the characters, the preset instructions, the selection instructions, and the selection modes. For example, without departing from the scope of the embodiments of the present invention, a first selection mode may also be referred to as a second selection mode, and similarly, a second selection mode may also be referred to as a first selection mode.

With continuous improvement of storage technologies, costs of storage media are continuously reduced, and people have increasing demands for information, photos, and electronic files. People also impose an increasing demand for rapid and efficient processing of a large amount of storage information. The embodiments of the present invention provide a multi-object processing method and device, to improve multi-object selection and processing efficiency, reduce a time, and save device power and resources.

The technical solutions in the embodiments of the present invention may be applied to a device of a computer system, for example, a mobile phone, a wristband, a tablet computer, a notebook computer, a personal computer, an ultra-mobile personal computer (“UMPC” for short), a personal digital assistant (“PDA” for short), a handheld device with a wireless communication function, a computing device, other processing device connected to a wireless modem, an in-vehicle device, or a wearable device.

Applicable operation objects of the processing method provided in the embodiments of the present invention may be pictures, photos, icons, files, applications, folders, SMS messages, instant messages, or characters in a document. The objects may be a same type of objects or different types of objects on an operation screen, or may be one or more same-type or different-type objects in a folder. The embodiments of the present invention do not limit an object type, and are neither limited to an operation performed only on same-type objects. For example, the operation may be performed on an icon and/or a file, an icon and/or a folder, and a folder and/or a file that are displayed on a screen, or an icon and/or a file, an icon and/or a folder, and a folder and/or a file that are in a folder, or a plurality of windows displayed on a screen. In the embodiments of the present invention, operation objects are not limited.

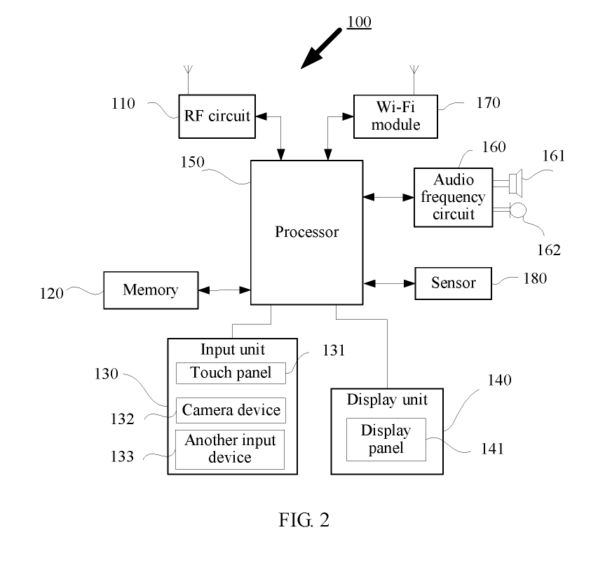

A device to which the embodiments of the present invention are applicable is described by using an example of a terminal 100 shown in FIG. 2. In this embodiment of the present invention, the terminal 100 may include components such as a radio frequency (Radio Frequency, “RF” for short) circuit 110, a memory 120, an input unit 130, a display unit 140, a processor 150, an audio frequency circuit 160, a Wireless Fidelity (Wireless Fidelity, “Wi-Fi” for short) module 170, a sensor 180, and a power supply.

A person skilled in the art may understand that a structure of the terminal 100 shown in FIG. 2 is an example instead of a limitation. The terminal 100 may alternatively include more or fewer components that those shown in the figure, or a combination of some components, or components disposed differently.

The RF circuit 110 may be configured to send and receive a signal in a process of information transmission/reception or during a call, and particularly, after receiving downlink information from a base station, send the downlink information to the processor 150 for processing. In addition, the RF circuit 110 sends uplink data of the terminal to the base station. Generally, the RF circuit includes but is not limited to an antenna, at least one amplifier, a transceiver, a coupler, a low noise amplifier (LNA), a duplexer, and the like. In addition, the RF circuit 110 may further communicate with a network and other device via wireless communication. The wireless communication may be performed by using any communications standard or protocol, including but not limited to a Global System for Mobile Communications (“GSM” for short), a general packet radio service (“GPRS” for short), Code Division Multiple Access (“CDMA” for short), Wideband Code Division Multiple Access (“WCDMA” for short), Long Term Evolution (“LTE” for short), an e-mail, a short message service (“SMS” for short), and the like. Although FIG. 2 shows the RF circuit 110, it can be understood that the RF circuit 110 is not a necessary constituent of the terminal 100 and can be omitted as necessary without changing the scope of the essence of the present invention. When the terminal 100 is a terminal used for communication such as a mobile phone, a wristband, a tablet computer, a PDA, or an in-vehicle device, the terminal 100 may include the RF circuit 110.

The memory 120 may be configured to store a software program and a module. The processor 150 runs the software program and the module stored in the memory 120, to execute various function applications and data processing of the terminal. The memory 120 may mainly include a program storage area and a data storage area. The program storage area may store an operating system, an application program required by at least one function (such as a sound playback function or an image playback function), and the like. The data storage area may store data (such as audio data or a phonebook) created based on use of the terminal, and the like. In addition, the memory 120 may include a high-speed random access memory, and may further include a non-volatile memory such as at least one magnetic disk storage component, a flash memory component, or other volatile solid-state storage component.

The input unit 130 may be configured to receive input digital or character information and generate a key signal related to user settings and function control of the terminal 100. Specifically, the input unit 130 may include a touch panel 131, a camera device 132, and other input device 133. The camera device 132 may shoot an image that needs to be obtained, and send the image to the processor 150 for processing. Finally, the image is presented to a user by using a display panel 141.

The touch panel 131, also referred to as a touchscreen, may collect a touch operation performed by the user on or in the vicinity of the touch panel 131 (for example, an operation performed on the touch panel 131 or in the vicinity of the touch panel 131 by the user by using a finger, a stylus, or any other suitable object or accessory), and drive a corresponding connection apparatus according to a preset program. Optionally, the touch panel 131 may include two parts: a touch detection apparatus and a touch controller. The touch detection apparatus detects a touch position of the user, detects a signal brought by a touch operation, and transmits the signal to the touch controller. The touch controller receives touch information from the touch detection apparatus, converts the touch information into touchpoint coordinates, and sends the touchpoint coordinates to the processor 150, and can receive a command sent from the processor 150 and execute the command. In addition, the touch panel 131 may be implemented in a plurality of types, such as a resistive type, a capacitive type, an infrared type, and a surface acoustic wave type.

In addition to the touch panel 131 and the camera device 132, the input unit 130 may include the other input device 132. Specifically, the other input device 132 may include but is not limited to one or more of a physical keyboard, a function key (such as a volume control key or a switch key), a trackball, a mouse, and a joystick. In this embodiment of the present invention, the input unit 130 may further include a microphone 162 and the sensor 180.

The audio frequency circuit 160, a loudspeaker 161, and the microphone 162 shown in FIG. 2 can provide an audio interface between the user and the terminal 100. The audio frequency circuit 160 may transmit, to the loudspeaker 161, an electrical signal that is obtained after conversion of received audio data, and the loudspeaker 161 converts the electrical signal into a sound signal and outputs the sound signal. In addition, the microphone 162 converts a collected sound signal into an electrical signal, the audio frequency circuit 160 receives the electrical signal and converts the electrical signal into audio data and outputs the audio data to the processor 150 for processing, and then processed data is sent to, for example, another terminal or a mobile phone, by using the RF circuit 110, or the audio data is output to the memory 120 for further processing. In this embodiment of the present invention, the microphone 162 may be further used as a part of the input unit 130, and is configured to receive a voice operation instruction that is input by the user. The voice operation instruction may be a voice control instruction and/or a voice selection instruction. The voice operation instruction may be used to control the terminal to enter a selection mode. The voice operation instruction may alternatively be used to control a selection operation of the terminal in the selection mode.

The sensor 180 in this embodiment of the present invention may be a light sensor. The light sensor 180 may include an ambient light sensor and a proximity sensor. The ambient light sensor may adjust luminance of the display panel 141 based on brightness of ambient light. The proximity sensor may turn off the display panel 141 and/or backlight when the terminal 100 is moved to an ear or the face of the user. In this embodiment of the present invention, the light sensor may be used as a part of the input unit 130. The light sensor 180 may detect a gesture that is input by the user and send, to the processor 150, the gesture as input. The display unit 140 may be configured to display information that is input by the user, information provided to the user, and various menus of the terminal. The display unit 140 may include a display panel 141. Optionally, the display panel 141 may be configured in a form of a liquid crystal display (LCD) unit, an organic light-emitting diode (OLED), or the like. Further, the touch panel 131 may cover the display panel 141. After detecting a touch operation on or in the vicinity of the touch panel 131, the touch panel 131 sends the touch operation to the processor 150 to determine a type of a touch event. Then the processor 150 provides corresponding visual output on the display panel 141 based on the type of the touch event.

The display panel 141 on which the visual output can be recognized by human eyes may be used as a display device in this embodiment of the present invention, and is configured to display text information or image information. In FIG. 2, the touch panel 131 and the display panel 141 are used as two separate components to implement input and output functions of the terminal; however, in some embodiments, the touch panel 131 may be integrated with the display panel 141 to implement the input and output functions of the terminal 100.

Wi-Fi is a short-distance wireless transmission technology. By using the Wi-Fi module 170, the terminal 100 may provide wireless broadband Internet access, send and receive an e-mail, browse a web page, access streaming media, and the like. Although FIG. 2 shows the Wi-Fi module 170, it can be understood that the Wi-Fi module 170 is not a necessary constituent of the terminal 100 and can be omitted as necessary without changing the scope of the essence of the present invention.

The processor 150 is a control center of the terminal 100, connects various parts of the entire terminal 100 by using various interfaces or lines, and executes various functions and data processing of the terminal 100 by running or executing the software program and/or the module stored in the memory 120 and invoking data stored in the memory 120, so as to perform overall monitoring on the terminal. Optionally, the processor 150 may include one or more processing units. Preferably, an application processor and a modem processor may be integrated into the processor 150. The application processor mainly processes an operating system, a user screen, an application program, and the like. The modem processor mainly performs wireless communication processing.

It can be understood that the modem processor may alternatively be not integrated into the processor 150.

The terminal 100 may further include a power supply (not shown in the figure) that supplies power to the components.

The power supply may be logically connected to the processor 150 by using a power supply management system, so as to implement functions such as charging and discharging management and power consumption management by using the power supply management system. Although not shown, the terminal 100 may further include a Bluetooth module, a headset jack, and the like, and details are not described herein.

It should be noted that the terminal 100 shown in FIG. 2 is an example of a computer system, and is not particularly limited in this embodiment of the present invention.

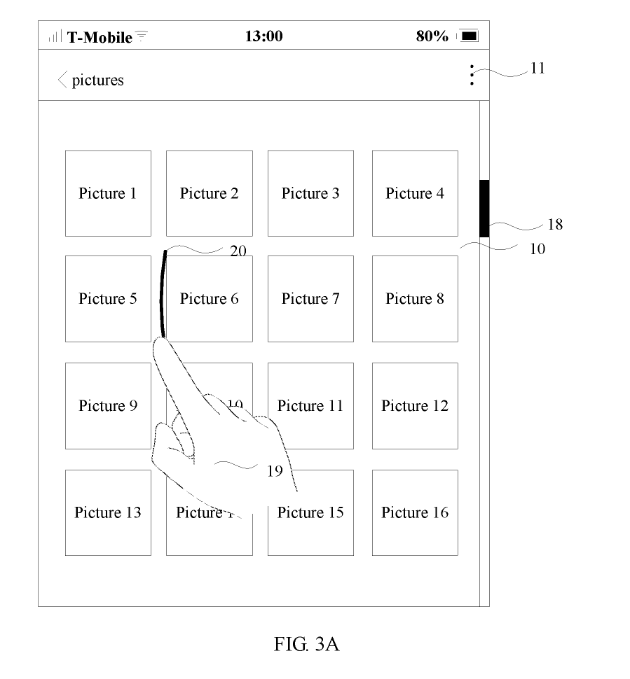

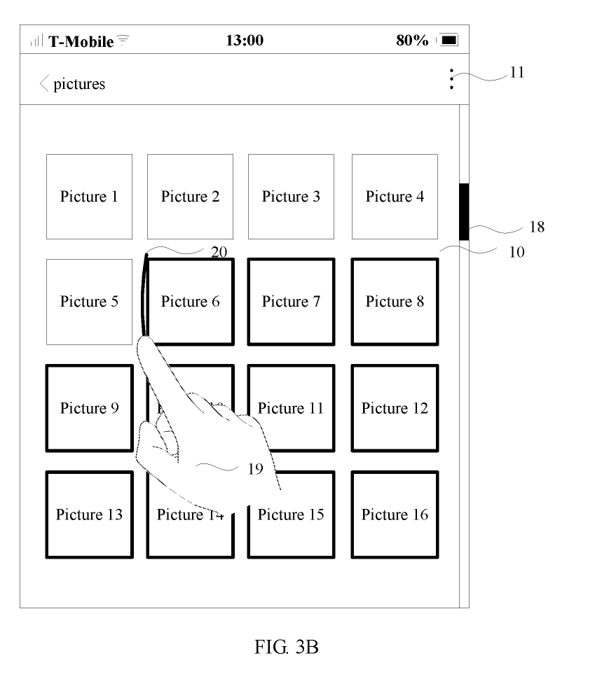

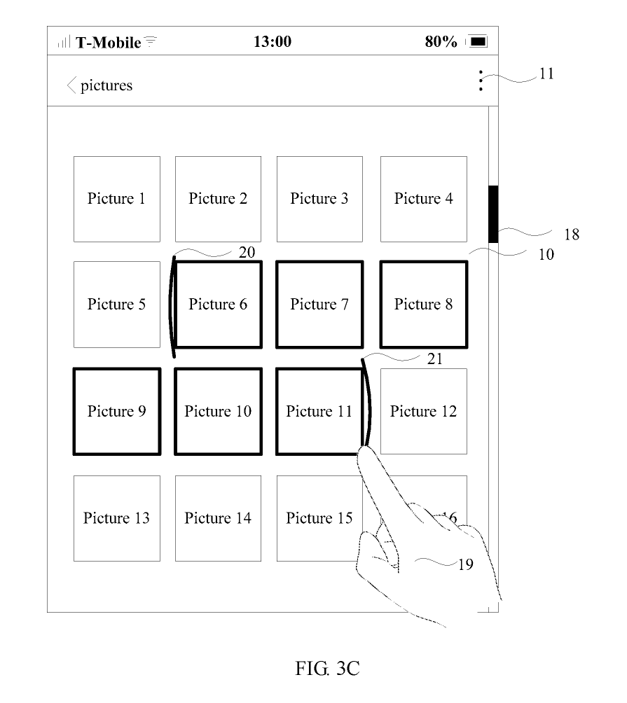

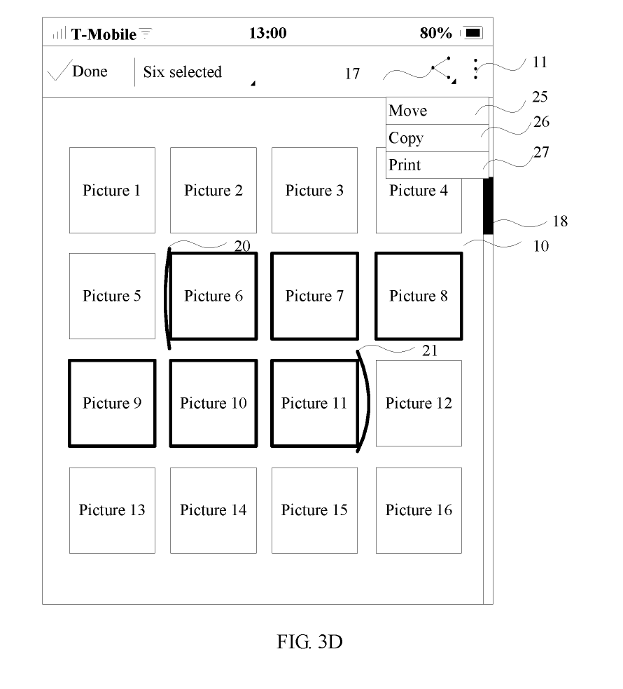

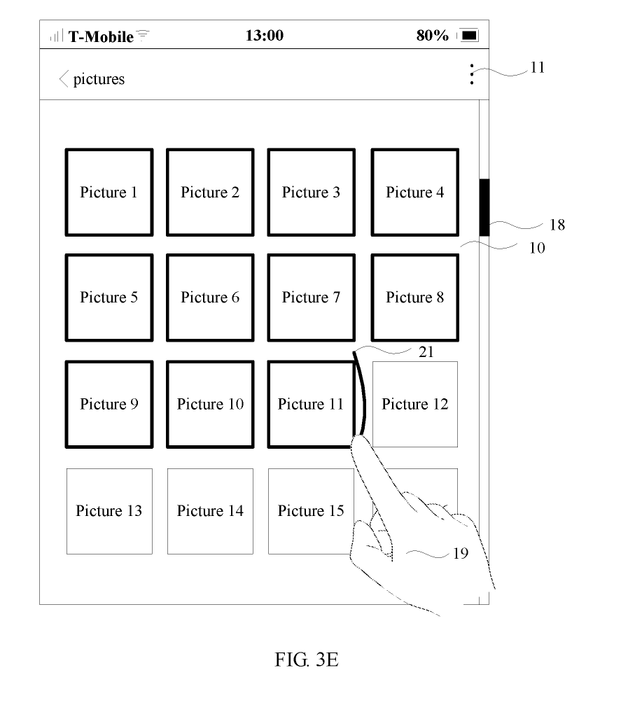

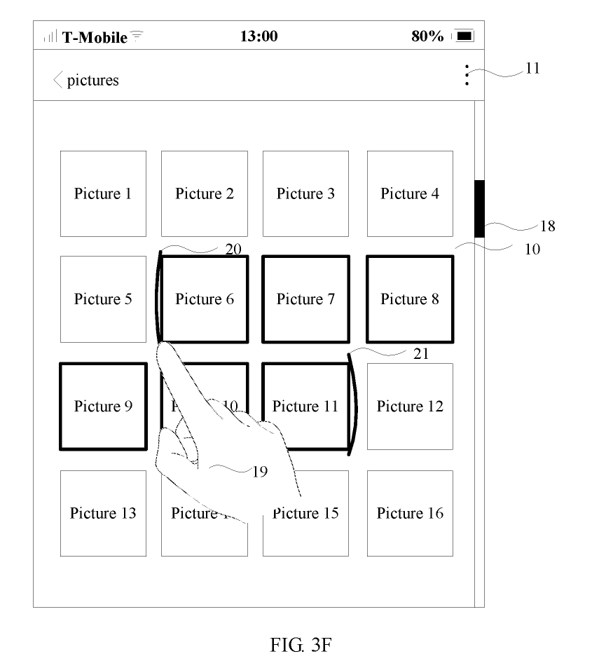

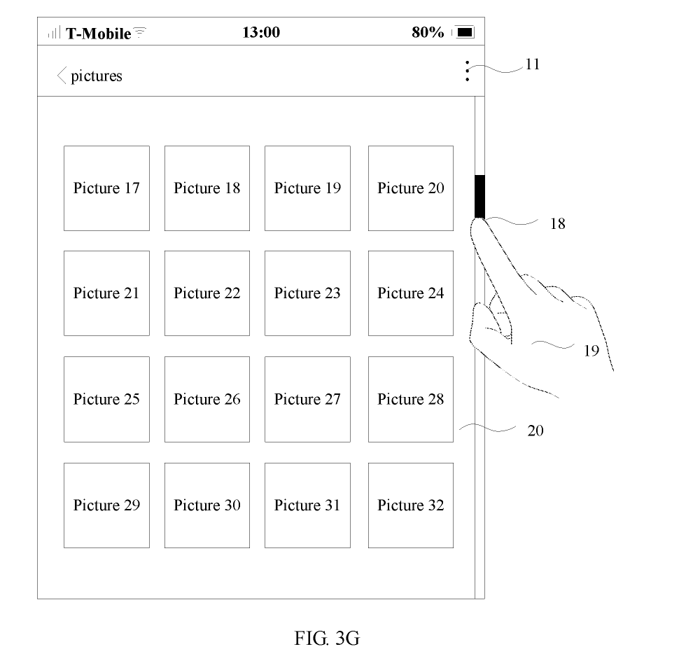

According to the technical solution of object processing provided in the embodiments of the present invention, an object on an operation screen or an object on a current display screen may be processed, or objects on a plurality of display screens may be processed. FIG. 3A to FIG. 3D are schematic diagrams of implementing multi-object processing for a gallery application of a terminal according to an embodiment of the present invention. The following describes a multi-object processing method provided in this embodiment of the present invention with reference to FIG. 2 and FIG. 3A to FIG. 3G.

The terminal 100 displays, by using the display unit 140, a gallery application screen 10 shown in FIG. 3A. A user may input an operation instruction by using the touch panel 131 of the terminal 100. The gallery application screen 10 in FIG. 3A displays pictures 1 to 16. The user may switch the gallery application screen by performing an up-and-down or left-and-right flick operation on the touch panel 131. The user may switch the gallery application screen by performing an operation on a scroll bar of the touch panel 131. As shown in FIG. 3G, the user may switch from the gallery application screen 10 to a gallery application screen 20 by sliding a scroll bar 18 up and down to perform a page turning operation. The scroll bar 18 may alternatively be set horizontally, that is, the user may switch from the gallery application screen 10 to the gallery application screen 20 by sliding the scroll bar left and right. The user can select target pictures on a plurality of application screens through page turning or switching of the gallery application screen 10, to implement batch selection and processing on a plurality of pictures on different screens.

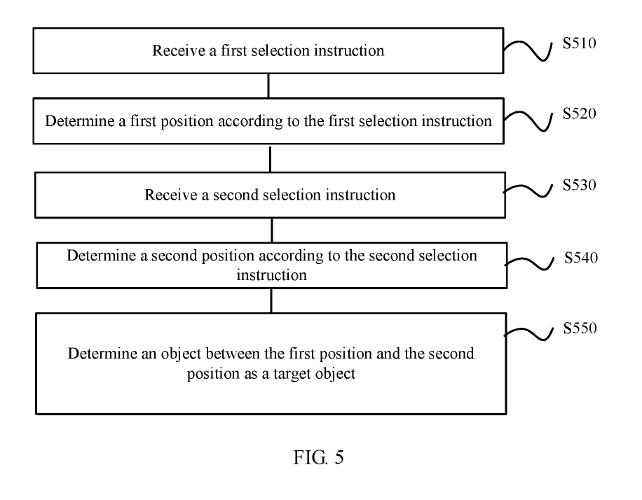

An implementation of a multi-selection mode provided in this embodiment of the present invention is described with reference to FIG. 3A and a schematic flowchart of a processing method in FIG. 5. The user may input a first selection instruction and a second selection instruction, to indicate a first position and a second position for object selection, respectively. The input unit 130 receives the first selection instruction, as shown in step S510. The input unit 130 sends the first selection instruction to the processor 150. The processor 150 determines the first position according to the first selection instruction, as shown in step S520. The input unit 130 receives the second selection instruction, as shown in step S530. The input unit 130 sends the second selection instruction to the processor 150. The processor 150 determines the second position according to the second selection instruction, as shown in step S540. The processor 150 determines an object between the first position and the second position as a target object, as shown in step S550. Alternatively, the processor 150 may determine a selection area based on the first position and the second position, and determine a target object based on the selection area. The processor 150 may further mark the target object as being in a selected state. According to the technical solution provided in this embodiment of the present invention, batch selection is implemented by separately inputting two selection instructions; this improves efficiency in selecting a plurality of objects by the terminal 100.

In some embodiments, the terminal may preset a first preset instruction and/or a second preset instruction. The processor 150 performs matching on the first selection instruction and the first preset instruction, and when the matching succeeds, determines that the first selection instruction is a selection instruction, and determines a position corresponding to the first selection instruction as the first position. The processor 150 performs matching on the second selection instruction and the second preset instruction, and when the matching succeeds, determines that the second selection instruction is a selection instruction, and determines a position corresponding to the second selection instruction as the second position. According to this technical solution, the terminal can preset a preset instruction, to implement rapid batch processing.

In this embodiment of the present invention, a preset time threshold may be set. If the input unit 130 detects the second selection instruction within the preset time threshold after receiving the first selection instruction, the processor 150 determines the target object according to the first selection instruction and the second selection instruction. If the input unit 130 receives no further operation instruction within the preset time threshold, the processor 150 may determine the target object according to the first selection instruction.

In some embodiments, the first preset instruction may be a start selection instruction or an end selection instruction, and correspondingly, the second preset instruction may be an end selection instruction or a start selection instruction. The first preset instruction and the second preset instruction each may alternatively be set as a start selection instruction or an end selection instruction.

In some embodiments, the first selection instruction may be a start selection instruction or an end selection instruction, and the first position may indicate a start position or an end position. Correspondingly, the second selection instruction may be an end selection instruction or a start selection instruction, and the second position may indicate an end position or a start position. In this embodiment of the present invention, an order of inputting the start selection instruction and the end selection instruction is not limited, and the user can input the start selection instruction and the end selection instruction randomly. The terminal 100 determines the target object according to a matched selection instruction. An instruction input form is not limited, and a recognition and processing capability of the terminal is improved.

In some embodiments, the terminal 100 supports continuous selection and discontinuous selection. The continuous selection is to determine an object in a selection area as a target object by performing one selection operation, that is, inputting the first selection instruction and the second selection instruction. The discontinuous selection is to determine objects in a plurality of selection areas as target objects by performing a plurality of selection operations. For example, the user may repeat a selection operation for a plurality of times, that is, separately input the first selection instruction and the second selection instruction for a plurality of times, to determine a plurality of selection areas. Objects in the plurality of selection areas are all determined as being selected. In this embodiment of the present invention, a target object in one selection area may be considered as one group of target objects, and target objects in the plurality of selection areas may be considered as a plurality of groups of target objects. The concept of the selection area is introduced for ease of description. The selection area may be determined based on an area in which the target object is located, or the selection area may be determined based on a selection instruction and then the target object is determined.

In some embodiments, before the user inputs a selection instruction, the gallery application screen displayed by the terminal is switched to a selection mode. The terminal 100 receives, by using the touch panel 131, the operation instruction that is input by the user, and determines to enter the selection mode according to the operation instruction. The selection mode in this embodiment of the present invention is a check-box mode or a multi-selection mode. The following describes, by using examples, operation manners of entering the selection mode.

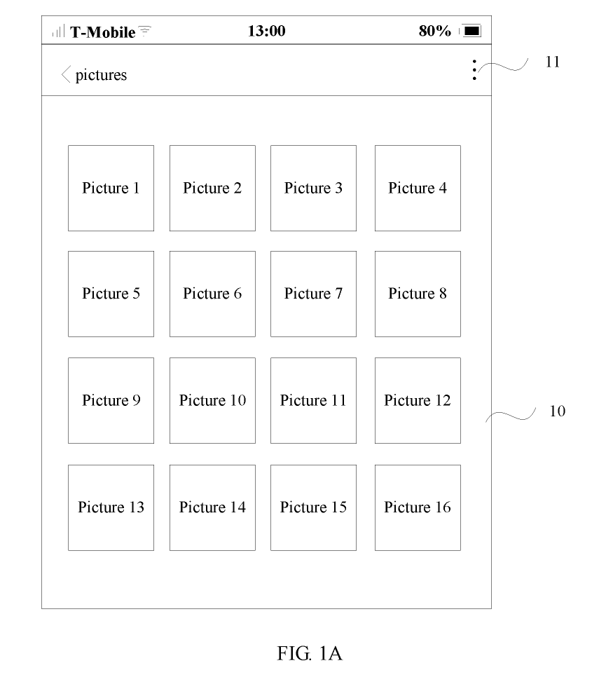

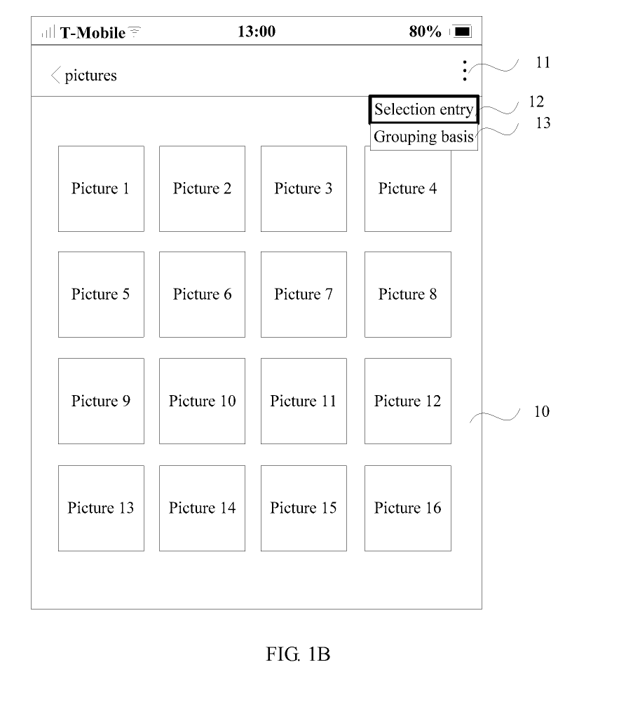

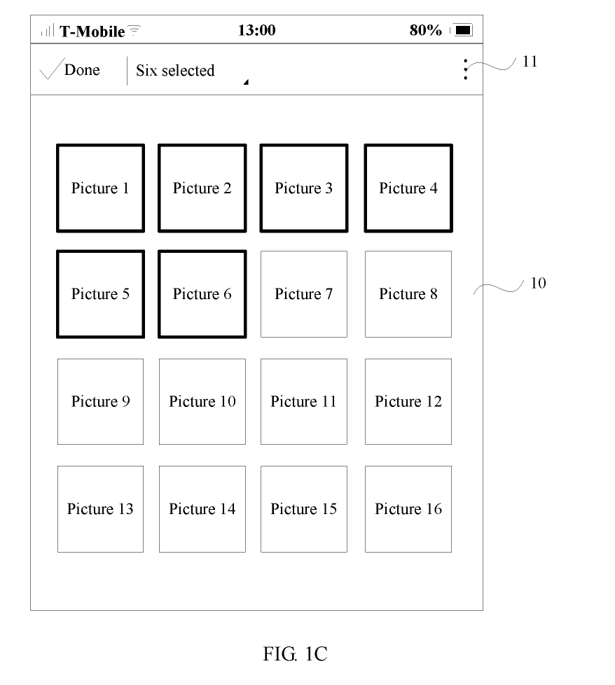

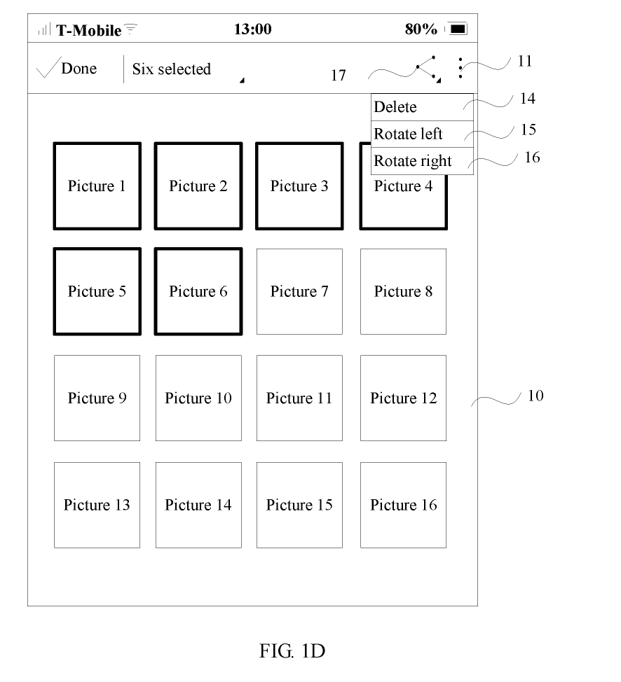

In an example, the user may enter the selection mode by using a menu option provided in an actionbar or a toolbar of the terminal 100, for example, a manner shown in FIG. 1B.

The user may tap a specified button displayed on a display screen of the terminal 100, to enter the selection mode. The specified button may be an existing button or a newly added button. For example, the specified button may be a “Select” button or an “Edit” button. For example, tapping the “Edit” button option may be considered as entering an editing state and entering the selection mode by default. The foregoing manner is applicable to various touchscreen devices and non-touchscreen devices. An operation may be input by using a touchscreen, or an operation may be input by using other input device such as a mouse, a keyboard, or a microphone.

For devices supporting touchscreen input, the user may alternatively enter the selection mode by long pressing an object or a blank space on the gallery application screen 10. Using FIG. 3A as an example, the user may long press a picture 6 with a finger 19 to enter the selection mode. The user may alternatively long press the blank space on the gallery application screen with the finger 19 to enter the selection mode.

If the terminal 100 supports a voice instruction control mode, the user may alternatively enter the selection mode by inputting voice. For example, in the voice instruction control mode, the user may say “Enter the selection mode” by using the microphone 162, and if the terminal 100 recognizes that this voice instruction instructs to enter the selection mode, the terminal 100 switches the gallery application screen 10 to the selection mode. In the selection mode, a “Done” button may further be set, and a plurality of selection operations are allowed before the “Done” button is tapped. In actual application, objects that the user wants to select may be presented discontinuously, and therefore allowing the user to perform discontinuous or intermittent selection operations improves convenience and efficiency of processing of the terminal.

In some embodiments, the selection mode is entered again due to interruption of an operation caused by a special case or a device fault, and the operation can also be continued based on a previous operation record. This avoids a repeated operation caused by a device fault.

In some embodiments, the user may input the selection instruction in different manners. For example, a manner of inputting the selection instruction by the user is described by using an example of a touchscreen. The user may separately input the first selection instruction and the second selection instruction in any area on the touchscreen with a finger. A TP (touch point) report point of the touchscreen may record first coordinates corresponding to the first selection instruction that is input by the finger and second coordinates corresponding to the second selection instruction that is input by the finger, and report the first coordinates and the second coordinates to the processor 150. The first coordinates are a start position, and the second coordinates are an end position. The processor 150 performs recording based on the reported first coordinates and second coordinates, and calculates an area covered between two coordinate positions, to determine the selection area.

In this embodiment of the present invention, the manner of inputting the selection instruction by the user may be applicable to various touchscreen devices and non-touchscreen devices. The user may input the selection instruction by using a touchscreen, or may input the selection instruction by using other input device such as a mouse, a keyboard, a microphone, or a light sensor. In this embodiment of the present invention, a specific input manner is not limited. In some embodiments, a preset selection instruction may be set as a track, a character, or a gesture. The preset selection instruction is preset as a specified track, character, or gesture. Description is provided by using an example in which the preset selection instruction includes the first preset instruction and the second preset instruction. The first preset instruction and the second preset instruction may be set as a same specified track, character, or gesture. The first preset instruction and the second preset instruction may alternatively be set to be corresponding to different tracks, characters, or gestures. Alternatively, the first preset instruction and the second preset instruction may be set as a group of tracks, characters, or gestures, and are a start selection instruction and an end selection instruction, respectively. The first preset instruction and the second preset instruction may be set by the terminal 100 by default, or may be set by the user. Setting the specified track, character, or gesture as the preset selection instruction can optimize internal processing of the terminal 100. The terminal 100 determines that an input track, character, or gesture performs matching on a preset track, character, or a gesture, determines that this input is a selection instruction, and performs a selection function. This avoids erroneous operations and increases efficiency.

In some embodiments, the start selection instruction may be preset as one of the following tracks, characters, or gestures: “(”, “[”, “{”, “˜”, “!”, “@”, “/”, “ [symbol] ”, “O”, “S”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “_”, “⁻”, “¬”, “ [symbol] ”, “ [symbol] ”, “ [symbol] ”, “ [symbol] ”, or “ [symbol] ”. The end selection instruction may be preset as one of the following tracks, characters, or gestures: “(”, “]”, “}”, “˜”, “!”, “@”, “\”, “ [symbol] ”, “O”, “T”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “_”, “⁻”, “¬”, “ [symbol] ”, “ [symbol] ”, “ [symbol] ”, “ [symbol] ”, or “ [symbol] ”. In this embodiment of the present invention, a specific form of the preset track, character, or gesture is not limited.

This embodiment of the present invention is described by using an example in which the preset selection instruction may be set as a preset track. For example, a first preset track is a preset start selection track, and a second preset track is a preset end selection track. The user inputs a first track by using the input unit 130. The processor 150 performs matching on the first track and the preset start selection track, and when the matching succeeds, determines that the first track is a start selection instruction, and determines a position corresponding to the first track as the start position. The processor 150 determines a start position of the selection area based on the start position. The user inputs a second track by using the input unit 130. The processor 150 performs matching on the second track and the preset end selection track, and when the matching succeeds, determines that the second track is an end selection instruction, and determines a position corresponding to the second track as the end position. The processor 150 determines an end position of the selection area based on the end position. The processor 150 determines the selection area based on the start position and the end position of the selection area, and determines the target object in the selection area based on the selection area. A track is set as a selection instruction, and a track that is input by the user each time is required to be relatively accurate. This can improve operability and security of a device.

Description is provided by using an example in which the preset selection instruction is set as a preset character. The processor 150 may recognize a corresponding character based on a track detected by the touch panel 131 or a gesture sensed by the light sensor 180, perform matching on the recognized character and the preset character, and when the matching succeeds, perform a selection function. Optionally, the user may alternatively input a character by using a keyboard, a soft keyboard, a mouse, or voice, and the processor 150 performs matching on the character that is input by the user and the preset character, and when the matching succeeds, performs a selection function. Setting the preset character as the preset selection instruction can improve accuracy and precision of a recognized selection instruction.

For example, description is provided with reference to FIG. 3A and FIG. 3C by using an example in which a preset start selection instruction is set as a first preset character “(” and a preset end selection instruction is set as a second preset character “)”. As shown in FIG. 3A, the touch panel 131 of the terminal 100 receives a track 20 “(” that is input by the user with the finger 19, and the touch panel 131 detects the track “(” and sends the track “(” to the processor 150. The processor 150 recognizes a character “(” based on the track “(”, performs matching on the recognized character “(” and the first preset character, and when the matching succeeds, determines that the user inputs the start selection instruction, and determines a position of the track 20 as the start position. As shown in FIG. 3C, the touch panel 131 receives a track 21 “)” that is input by the user with the finger 19, and the touch panel 131 detects the track “)” and sends the track “)” to the processor 150. The processor 150 recognizes a character “)” based on the track “)”, performs matching on the recognized character “)” and the second preset character, and when the matching succeeds, determines that the user inputs the end selection instruction, and determines a position of the track 21 as the end position. The processor 150 determines the selection area as an area between the track 20 and the track 21 based on the start position and the end position, and determines pictures 6 to 11 in the area as selected target objects. The target objects are marked as being in a selected state. According to this technical solution, the terminal determines the selection area based on the start position and the end position, and determines the target objects, easily and rapidly implementing multi-object selection.

For example, description is provided by using an example in which the preset selection instruction is set as a preset gesture. The light sensor 180 senses a gesture that is input by the user. The processor 150 compares the gesture that is input by the user with the preset gesture, and when the two match, performs a selection function. Because a gesture that is input by the user each time is not completely the same, in a matching process, an error is allowed. The preset gesture is set as the preset selection instruction, and a gesture that is input by the user each time is required to be relatively accurate. This can improve operability and security of a device.

For example, description is provided by using an example in which a preset start selection instruction is a preset track “(”. When the user draws a track “(” on the touch panel 131, the touch panel 131 detects the track “(” and sends the track “(” to the processor 150. The processor 150 performs matching on the track “(” and the preset track, and when the matching succeeds, determines that the user inputs the start selection instruction, and performs a selection function for the instruction. In this embodiment of the present invention, a specific form of the preset track is not limited. A manner of the preset gesture is similar, and details are not described herein again.

In some embodiments, setting the specified track, character, or gesture as the preset selection instruction improves a processing capability of the terminal. In this embodiment of the present invention, when the preset selection instruction is a group of selection instructions, that is, the preset start selection instruction and the preset end selection instruction, the terminal may not limit an order of receiving the start selection instruction and the end selection instruction that are input by the user. The user may first input the end selection instruction, or first input the start selection instruction. The processor 150 compares a track, a character, or a gesture that is input by the user with a preset track, character, or gesture, determines that the selection instruction that is input by the user is the start selection instruction or the end selection instruction, and determines the selection area based on a matching result.

In some embodiments, the processor 150 may determine the selection area or the target object based on a preset selected mode. For example, the selected mode may be a horizontal selection mode, a longitudinal selection mode, a direction attribute mode, a unidirectional selection mode, a closed image selection mode, or the like. The foregoing different selected modes may be switched between each other. In this embodiment of the present invention, a specific selected mode is not limited. For example, using the direction attribute mode as an example, the processor 150 may determine the selection area or the target object based on a direction attribute of the selection instruction that is input by the user.

The following uses an example in which the preset selection instruction is the preset character, to describe cases to which different selected modes are applicable.

A case to which the horizontal selection mode is applicable is described as an example. The horizontal selection mode may be applicable to a row selection manner. In the applicable horizontal selection mode, an input character may have no direction attribute.

With reference to FIG. 3A and FIG. 3C, description is provided by using an example in which a preset start selection character (the first preset character) is set as the character “(” and a preset end selection character (the second preset character) is set as the character “)”. The user inputs the track 20 “(” by using the touch panel 131. The processor 150 recognizes the character “(” corresponding to the track 20, performs matching on the character “(” and the preset start selection character, and when the matching succeeds, determines that the position of the track 20 is corresponding to the start position. The user inputs the track “)” by using the touch panel 131. The processor 150 recognizes the character “)” corresponding to the track 21, performs matching on the character “)” and the preset end selection character, and when the matching succeeds, determines that the position of the track 21 is corresponding to the end position. The processor 150 determines the area between the track 20 and the track 21 as the selection area, and determines pictures 6 to 11 in the selection area as selected target objects. The target objects are marked as being in a selected state.

Using FIG. 3C as an example for description, the track 20 “(” is corresponding to the first character, and the track 21 “)” is corresponding to the second character. The first preset character and the second preset character may be considered as a group of preset characters. The first character and the second character may be considered as a group of selection instructions that are input by the user. When the group of characters that are input by the user successfully match the preset characters, objects between the first character and the second character can be selected across rows. When the group of character selection instructions that are input by the user are in different rows, an area from the first character to the end of a row in which the first character is located, an area from the second character to the beginning of a row in which the second character is located, and an area of a row between the row in which the first character is located and the row in which the second character is located are all determined as the selection area, and objects in the selection area are all selected. When the group of characters, namely the first character and the second character, are located in a same row, objects between “(” and “)” in the row are all selected.

Determining the selection area in the applicable horizontal selection mode can effectively improve selection efficiency of continuous objects sorted in a regular order. Discontinuous objects can be selected for a plurality of times by intermittently inputting a plurality of selection instructions. This improves operability of batch processing.

A case to which the unidirectional selection mode is applicable is described as an example. The unidirectional selection mode may be applicable to a row selection manner, or may be applicable to a column selection manner. In the applicable unidirectional selection mode, the input character may have no direction attribute.

In an embodiment to which the unidirectional selection mode is applicable, the user may implement multi-object batch selection by inputting only the first selection instruction. The first selection instruction may be a start selection instruction, or may be an end selection instruction.

For example, if the user wants to edit all objects after a date or a position, the user may input only a start selection instruction to complete a selection operation. As shown in FIG. 3B, the touch panel 131 detects the track 20 that is input by the finger 19, and sends the track 20 to the processor 150. The processor 150 recognizes that the track 20 is corresponding to the character “(”, and the character “(” matches the preset start selection character. The processor 150 may determine the start position of the selection area based on the position of the track 20, and determine an area after the start position as the selection area. The processor 150 marks target objects in the selection area as being in a selected state. That is, pictures 6 to 16 are all identified as selected target objects. In the applicable unidirectional selection mode, the terminal 100 can rapidly determine the target objects, thereby improving a processing capability. According to this embodiment of the present invention, if the user wants to edit an object after a date or a position, the user can input a start selection instruction, to implement multi-object selection.

In some embodiments, the selected modes are mutually switchable. Description is provided with reference to FIG. 3B and FIG. 3C. As shown in FIG. 3B, the processor 150 determines, based on the unidirectional selection mode, that selected target objects are pictures 6 to 16. As shown in FIG. 3C, the touch panel 131 continues to detect the track 21 “)” that is input by the finger 19. The processor 150 recognizes that the track 21 is corresponding to the character “)”, and the character “)” matches the preset end selection character. The processor 150 may determine the end position of the selection area based on the position of the track 21. Therefore, the processor 150 switches from the applicable unidirectional selection mode to the applicable horizontal selection mode, determines an area between the track 20 and the track 21 as the selection area, determines pictures 6 to 11 as target objects, and keeps being-selected identification of the pictures 6 to 11 unchanged. The processor 150 cancels being-selected identification of objects, namely the pictures 12 to 16, in a non-selection area. According to this technical solution, the terminal can determine, based on detected user input, whether the unidirectional selection mode or the horizontal selection mode is applicable, and can flexibly switch the selected mode. This improves a processing speed and efficiency of the terminal.

In some embodiments, for example, if the user wants to edit all objects before a date or a position, the user can input only an end selection instruction to complete a selection operation. As shown in FIG. 3E, the touch panel 131 detects the track 21 that is input by the finger 19. The processor 150 recognizes that the track 21 is corresponding to the character “)”, and determines that the character “)” matches the preset end selection character. The processor 150 may determine the end position of the selection area based on the position of the track 21. The processor 150 determines that the unidirectional selection mode is applicable, and determines an area before the end position as the selection area. The processor 150 determines pictures 1 to 11 in the selection area as target objects, and marks the target objects as being in a selected state. According to this embodiment of the present invention, if the user wants to edit an object before a date or a position, the user can input an end selection instruction, to implement multi-object selection.

Another implementation of this embodiment of the present invention is described with reference to FIG. 3E and FIG. 3F. As shown in FIG. 3E, the processor 150 may determine, based on the track 21, that target objects are pictures 1 to 11. As shown in FIG. 3F, after the touch panel 131 further detects the track 20 “(” that is input by the user, the processor 150 recognizes a character corresponding to the track 20, determines that the character matches the preset start selection character, and determines that the user has input a start selection instruction. The processor 150 determines an area between the track 20 and the track 21 as the selection area, determines pictures 6 to 11 as target objects, and keeps being-selected identification of the pictures 6 to 11 unchanged. The processor 150 cancels being-selected identification of objects, namely the pictures 1 to 5, in a non-selection area. According to this embodiment of the present invention, the terminal monitors in real time a selection instruction that is input by the user, and determines selected target objects in real time, improving batch selection and processing efficiency of objects.

In some embodiments, the terminal may set a time threshold between reception of the start selection instruction and reception of the end selection instruction. After the user inputs the start selection instruction or the end selection instruction, the touch panel 131 detects, within a preset time threshold, a new selection instruction that is input by the user. After determining that the new selection instruction is the end selection instruction or the start selection instruction, the processor 150 determines the selection area based on the start position and the end position of the selection instructions. If the touch panel 131 does not detect a new selection instruction within the preset time threshold, the processor 150 determines that the input start selection instruction or end selection instruction is applicable to the unidirectional selection mode. The processor 150 determines the selection area based on the unidirectional selection mode. In this embodiment of the present invention, an order of inputting the start selection instruction and the end selection instruction is not limited.

A case to which the longitudinal selection mode is applicable is described as an example. The longitudinal selection mode may be applicable to a column selection manner. In the applicable longitudinal selection mode, an input character may have no direction attribute.

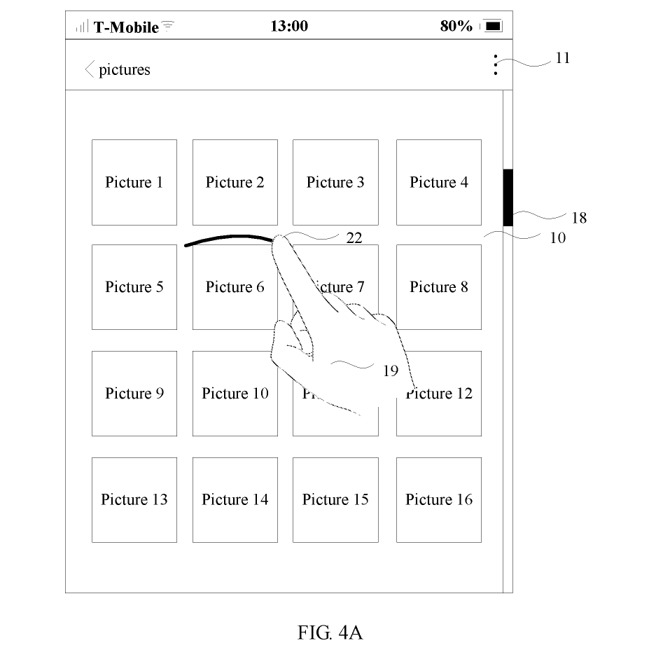

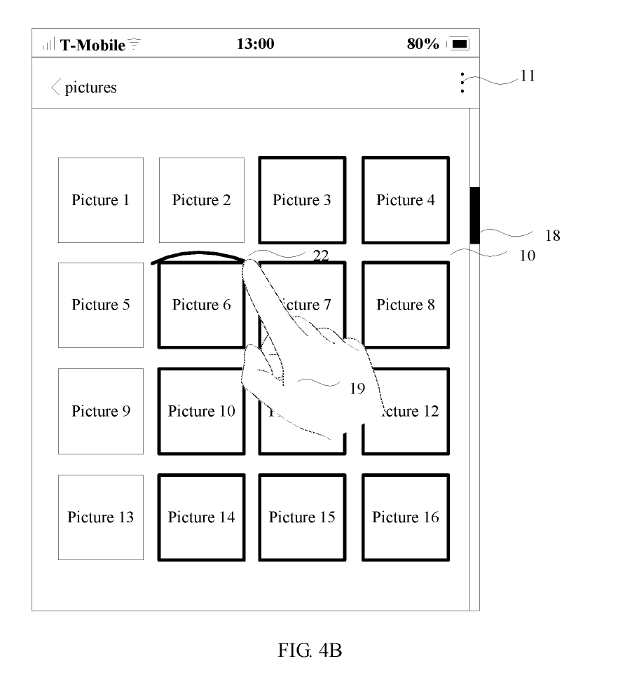

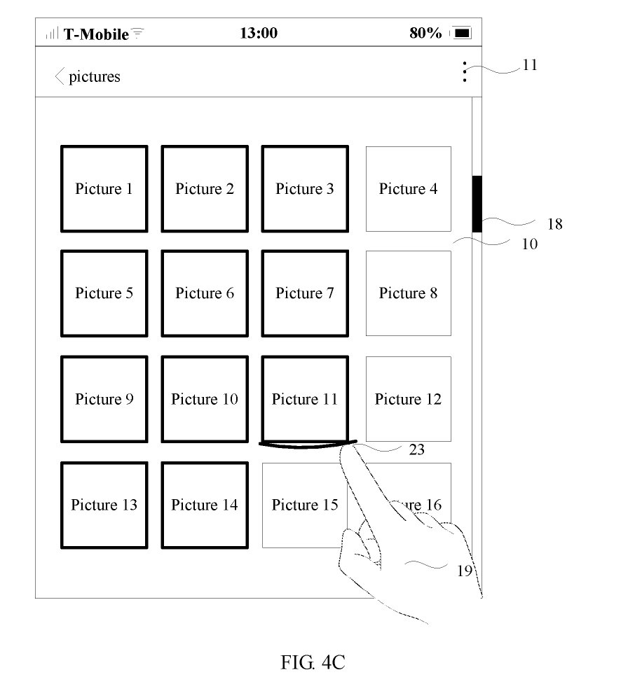

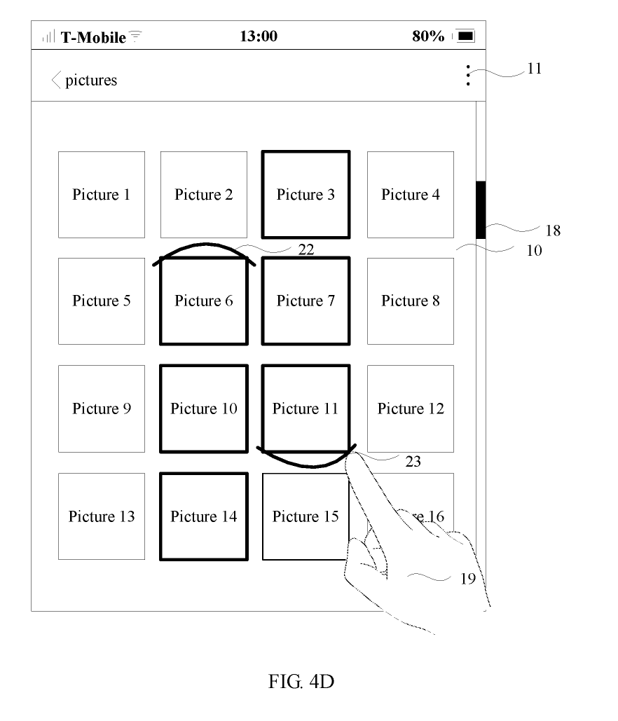

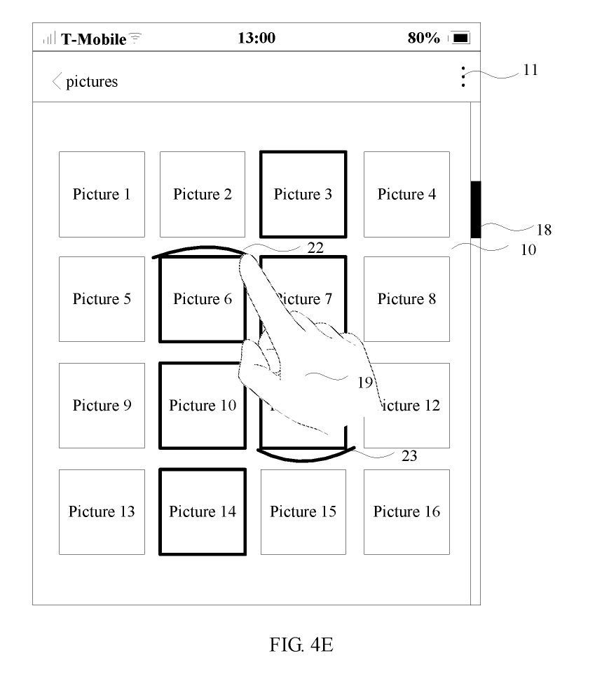

Description is provided with reference to FIG. 4A and FIG. 4E. Description is provided by using an example in which the preset start selection character is set as a character “ [symbol] ” and the preset end selection character is set as a character “ [symbol] ”. As shown in FIG. 4A, the user inputs a track 22 “ [symbol] ” by using the touch panel 131. The processor 150 recognizes that the character “ [symbol] ” corresponding to the track 22 matches the preset start selection character, and determines that a position of the track 22 is corresponding to the start position. As shown in FIG. 4D, the user inputs a track 23 “ [symbol] ” by using the touch panel 131. The processor 150 recognizes that the character “ [symbol] ” corresponding to the track 23 matches the preset end selection character, and determines that a position of the track 23 is corresponding to the end position. The processor 150 determines an area between the track 22 and the track 23 as the selection area, and determines pictures 6, 10, 14, 3, 7, and 11 in the selection area as selected target objects. The target objects are marked as being in a selected state.

Using FIG. 4D as an example for description, the track 22 “ [symbol] ” is corresponding to a third character, and the track 23 “ [symbol] ” is corresponding to a fourth character. The third character and the fourth character may be considered as a group of characters.

In the applicable longitudinal selection mode, objects between the third character and the fourth character are selected in a longitudinal manner, or may be selected across columns. When a group of input characters are located in a same column, objects between the third character and the fourth character in this column are all selected. When a group of input characters are located in different columns, an area from the third character to the end of a column in which the third character is located, an area from the fourth character to the beginning of a column in which the fourth character is located, and an area of a column between the column in which the third character is located and the column in which the fourth character is located are all determined as the selection area, and objects in the selection area are all selected.

In some embodiments, when the user inputs only the start selection instruction, objects in a column area after an input position of the start selection instruction are all selected. Using FIG. 4B as an example for description, if the user inputs the track 22 by using the touch panel 131, the processor 150 may apply a selected mode to objects in an area to the right of a facing direction of the track 22, and determine pictures 6, 10, 14, 3, 7, 11, 15, 4, 8, 12, and 16 as selected target objects. Optionally, the processor 150 may alternatively apply a selected mode to objects in an area to the left of a facing direction of the track 22, and determine pictures 6, 10, 14, 1, 5, 9, and 13 as selected target objects. In this embodiment of the present invention, the applicable selected mode is not specifically limited.

Description is provided by using an example in which the processor 150 applies the selected mode to the objects in the area to the right of the facing direction of the track 22. The processor 150 determines the pictures 6, 10, 14, 3, 7, 11, 15, 4, 8, 12, and 16 as selected target objects. With reference to FIG. 4D, after the touch pane 131 detects the track 23 that is input by the user, the processor 150 recognizes a character corresponding to the track 23 and determines the character as the end selection instruction. The processor determines the area between the track 22 and the track 23 as the selection area, determines the pictures 6, 10, 14, 3, 7, and 11 as target objects, and keeps being-selected identification of the pictures 6, 10, 14, 3, 7, and 11 unchanged. The processor 150 cancels being-selected identification of the pictures 15, 4, 8, 12, and 16.

In some embodiments, the user may alternatively input only the end selection instruction for selection. As shown in FIG. 4C, the touch panel 131 detects the track 23 that is input by the finger 19. If the processor 150 recognizes that the character corresponding to the track 23 matches the preset end selection character, the processor 150 determines that the position of the track 23 is the end position, and determines an area before the end position as a selected area. For example, the processor 150 may determine pictures 1, 2, 3, 5, 6, 7, 9, 10, 11, 13, and 14 as target objects, and mark the target objects as being in a selected state.

In some embodiments, after inputting the end selection instruction, the user may further input the start selection instruction. Description is provided with reference to FIG. 4C and FIG. 4E. As shown in FIG. 4C, the processor 150 determines the pictures 1, 2, 3, 5, 6, 7, 9, 10, 11, 13, and 14 as the target objects. In FIG. 4E, the touch panel 131 continues to detect the track 22 that is input by the finger 19. If the processor 150 recognizes that the character corresponding to the track 22 matches the preset start selection character, the processor 150 determines that the position of the track 22 is the start position. The processor 150 determines the area between the track 22 and the track 23 as the selection area, and determines the pictures 6, 10, 14, 3, 7, and 11 as target objects.

A case to which the direction attribute selection mode is applicable is described as an example. A character that is input by the user has a direction attribute and may be applicable to the direction attribute selection mode, and objects in a facing direction of the character that is input are all selected.

Using FIG. 3B as an example, objects in an area to the right of a facing direction of the first character “(” that is corresponding to the track 20 are all selected, that is, the pictures 6 to 16 are all selected. Using FIG. 3E as an example, objects in an area to the left of a facing direction of the second character “)” that is corresponding to the track 21 are all selected, that is, the pictures 1 to 11 are all selected. Using FIG. 4B as an example, objects in an area to the right of a facing direction of the character “ [symbol] ” that is corresponding to the track 22 are all in the selected mode, that is, the pictures 6, 10, 14, 3, 7, 11, 15, 4, 8, 12, and 16 are all selected. Optionally, objects in an area to the left of a facing direction of the character may alternatively be set to be selected. This is not limited in this embodiment of the present invention. Using FIG. 4C as an example, objects in an area to the left of a facing direction of the character “ [symbol] ” that is corresponding to the track 23 are all selected, that is, the pictures 1, 2, 3, 5, 6, 7, 9, 10, 11, 13, and 14 are all selected. Optionally, objects in an area to the right of a facing direction of the character may alternatively be set to be selected. This is not limited in this embodiment of the present invention.

In some embodiments, the processor 150 may determine, as selected target objects, a start object of the start position corresponding to the start selection instruction and all objects after the start object. The processor 150 may determine, as selected target objects, objects between the start object corresponding to the start position and a last object on a current display screen. The processor 150 may alternatively determine, as selected target objects, objects between the start object corresponding to the start position and a last object on a last display screen, that is, perform selection across screens.

Determining the selection area in the applicable direction attribute mode greatly improves efficiency in selecting continuous objects sorted in a directional and regular order.

In some embodiments, description is provided by using FIG. 3B and FIG. 3C as an example. The processor 150 may determine the selection area based on a preset horizontal selection mode. The processor 150 may alternatively determine, based on the characters “(” and “)”, an attribute mode as horizontal expansion, so as to determine the selection area. The processor 150 may alternatively determine, based on the characters “(” and “)”, a direction attribute mode as horizontal expansion, so as to determine the selection area.

In this embodiment of the present invention, the terminal 100 may further perform processing on a plurality of selected objects according to an operation instruction. The operation instruction may be input by using an operation option. The operation option may be displayed by using a menu option. The menu option may set to include one or more operation options, such as operation options of delete, copy, move, save, edit, print or generate PDFs, or display details. As shown in FIG. 3D, the user may tap a menu option 11 in the upper right corner, and the following submenus are displayed: move 25, copy 26, and print 27. The user may select a submenu option to perform a batch operation on the selected pictures 6 to 11. The user may further tap a share option 17 to the left of the menu option 11, to share the selected pictures 1 to 6. The submenu option in the menu option may be set as an option commonly used by the user or an option with a high application probability. This is not limited in this embodiment of the present invention.

In some embodiments, the operation option may alternatively be displayed by using an operation icon. On an operation screen, one or more operation icons may be set. The operation icon may be displayed above or below the operation screen. The operation icon may be corresponding to an operation commonly used by the user, such as delete, copy, edit, move, save, edit, or print. The user may input an operation instruction by selecting an operation option in an operation menu, or may perform selection by tapping the operation icon. The processor 150 may perform batch processing on the plurality of selected objects according to the operation instruction that is input by the user. Selecting the plurality of objects rapidly at a time can improve convenience and efficiency in performing batch processing on the objects by the terminal 100. During processing of a large amount of data, advantages of the technical solution provided in this embodiment of the present invention are more obvious.

In the embodiments of the present invention, this embodiment of the present invention is further described by using an example in which a check-box operation is performed on icons of a screen of the mobile terminal. A batch operation can be implemented on a plurality of icons at a time. Repeated operations performed on individual icons change to a batch operation performed on a plurality of icons at a time.

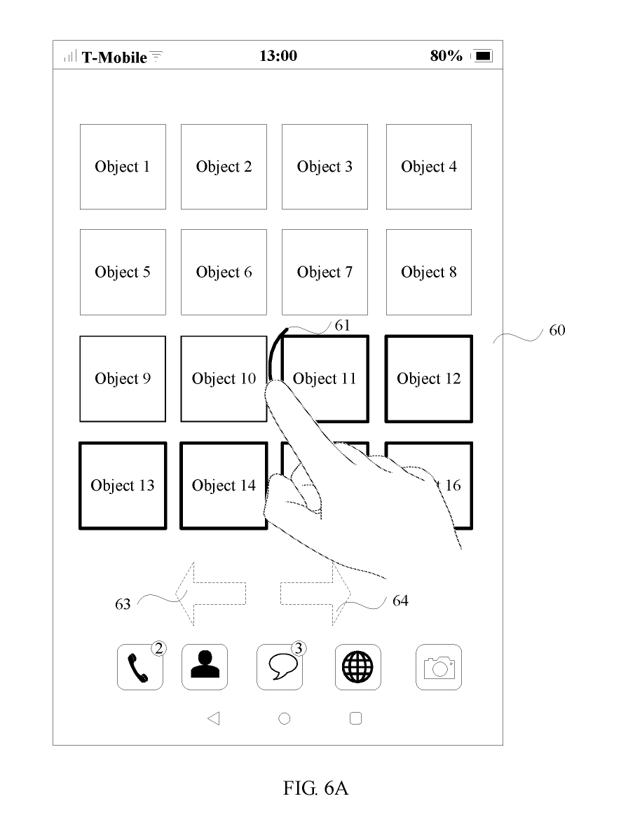

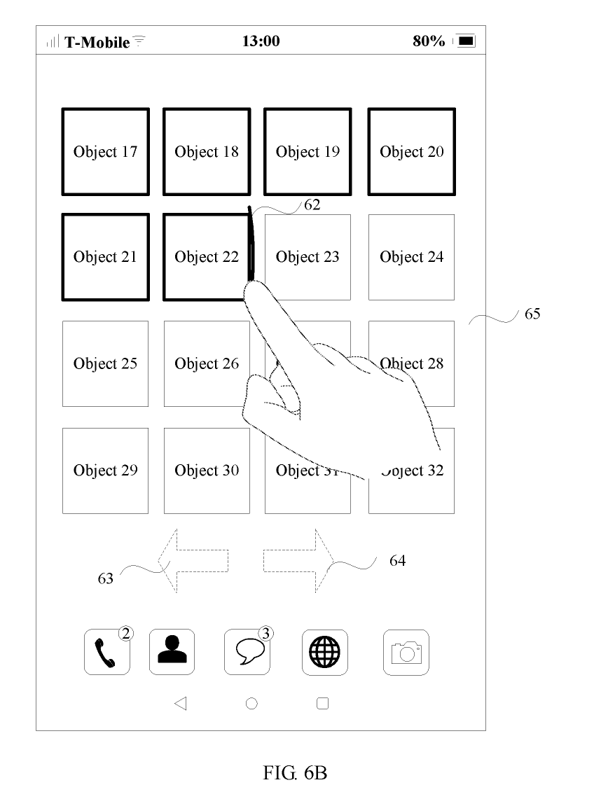

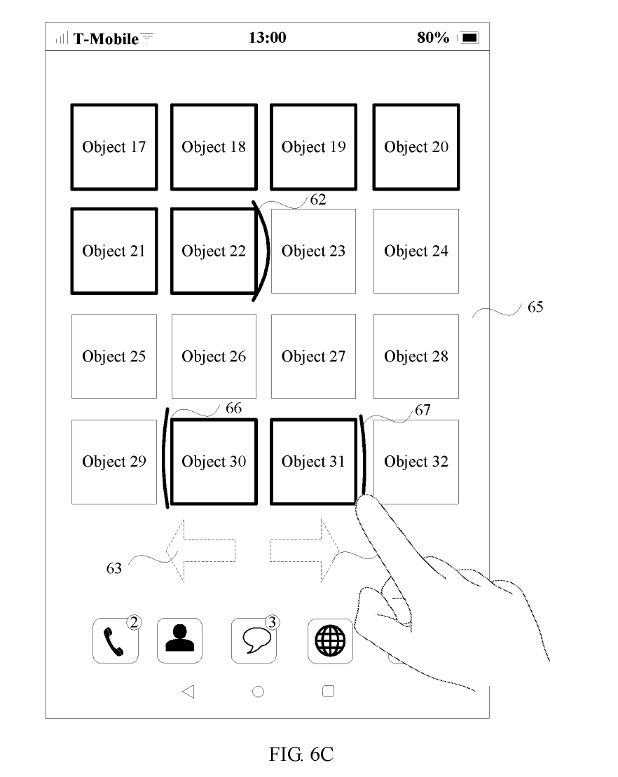

With reference to FIG. 6A and FIG. 6B, description is provided by using an example in which the preset selection instruction is a preset track and an operation is performed on icons of a mobile phone display screen. FIG. 6A shows a first display screen 60 of a mobile phone. In the middle of the first display screen 60, 16 icons, namely objects 1 to 16, are displayed. Below the first display screen 60, an application icon commonly used by the user is further displayed. The user may input a track 61 by using the touch panel 131. The processor 150 determines that the track 61 is a start selection instruction, and may first determine the objects 11 to 16 as selected target objects, or may wait for the user to input an end selection instruction. The user may perform a selection operation on the current display screen, or may switch the display screen and perform a selection operation on other display screen. The user may perform a page turning operation on the display screen of the mobile phone by performing left-and-right sliding. On the first display screen 60, a virtual page turning button, for example, a virtual button 63 and a virtual button 64, may be further set. The user may switch to a previous display screen by tapping the virtual button 63, and may switch to a next display screen by tapping the virtual button 64. As shown in FIG. 6A, the user may tap the virtual button 64 to enter a second display screen 65, as shown in FIG. 6B. In the middle of the second display screen 65, objects 17 to 32 are displayed. The user may input a selection instruction on the second display screen, to continue with the selection operation. The touch panel 131 detects a track 62 that is input by the user. When determining that the track 62 is an end selection instruction, the processor 150 determines a position of the track 62 as an end position. The processor 150 determines an area between the track 61 and the track 62 as a selection area, and determines the objects 11 to 22 as target objects. In this embodiment of the present invention, different display screens are switched in a process of inputting an operation instruction, and the operation instruction is input, so as to facilitate the operation. Switching between display screens does not affect inputting the operation instruction. The technical solution provided in this embodiment of the present invention facilitates target objects that are distributed in areas with good continuity and improves batch processing efficiency.

In some embodiments, as shown in FIG. 6C, after the user completes inputting of a group of selection instructions, for example, the track 61 and the track 62, to select first target objects 11 to 22, the user may continue to input a second group of selection instructions, for example, a track 66 and a track 67, to continue to select second target objects 30 and 31, so as to implement multi-group selection of discontinuous objects. By analogy, the user may switch to another display screen and input a selection instruction, to continue with the multi-selection operation. In this embodiment of the present invention, a plurality of groups of selection instructions are used, so that for object processing of target objects that are distributed in areas with poor continuity, selection efficiency is effectively improved, and a batch processing capability is enhanced.

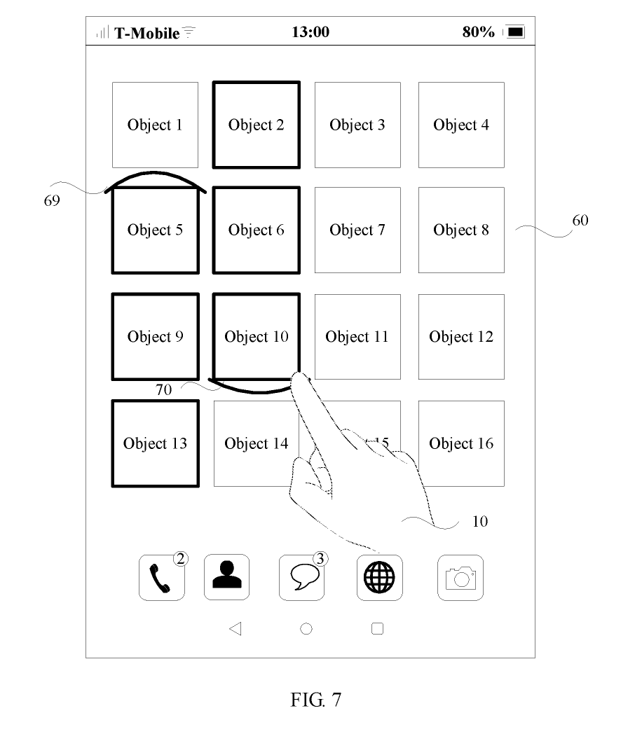

With reference to FIG. 7, description is provided by using an example in which the preset selection instruction is a preset gesture and an operation is performed on icons of a mobile phone display screen. As shown in FIG. 7, the first display screen 60 of the mobile phone displays objects 1 to 16. The user may perform a selection operation by inputting a gesture 69 and a gesture 70. The light sensor 180 senses the gesture 69 and the gesture 70 that are input by the user. The processor 150 determines that the gesture 69 matches a preset start selection gesture, and that the gesture 70 matches a preset end selection gesture. The processor 150 determines that an area between the gesture 69 and the gesture 70 is a selection area, and determines that the objects 5, 9, 13, 2, 6, and 10 are target objects.

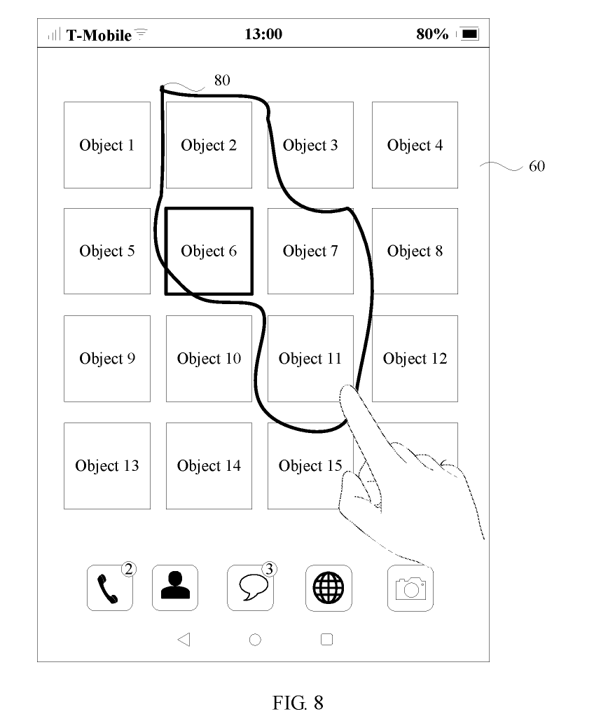

In some embodiments, the terminal 100 further supports determining a selection area by using a closed track/gesture/graph/curve, so as to determine a target object. The closed track/gesture/graph/curve may be in any shape. As shown in FIG. 8, the user inputs a closed track 80 by using the touch panel 131, and the processor 150 determines, based on the closed track 80, that objects 2, 6, 7, and 11 within the closed curve are all selected.

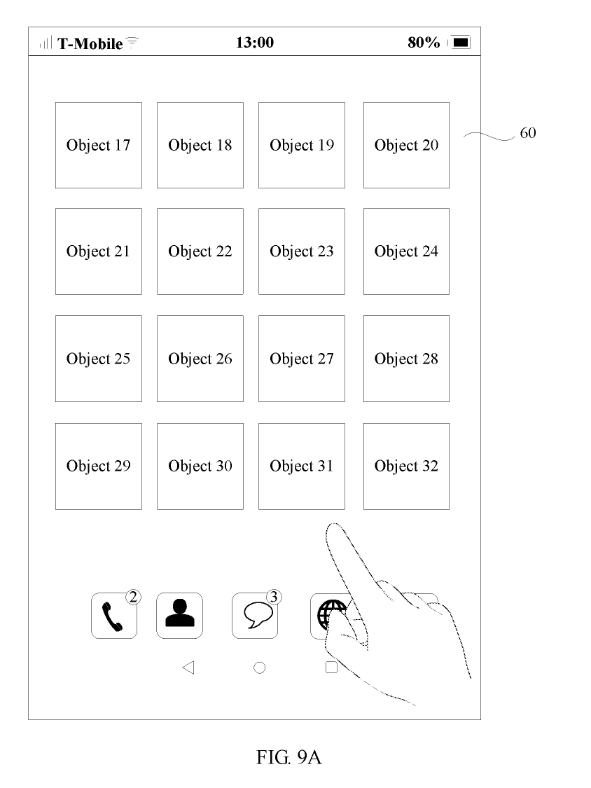

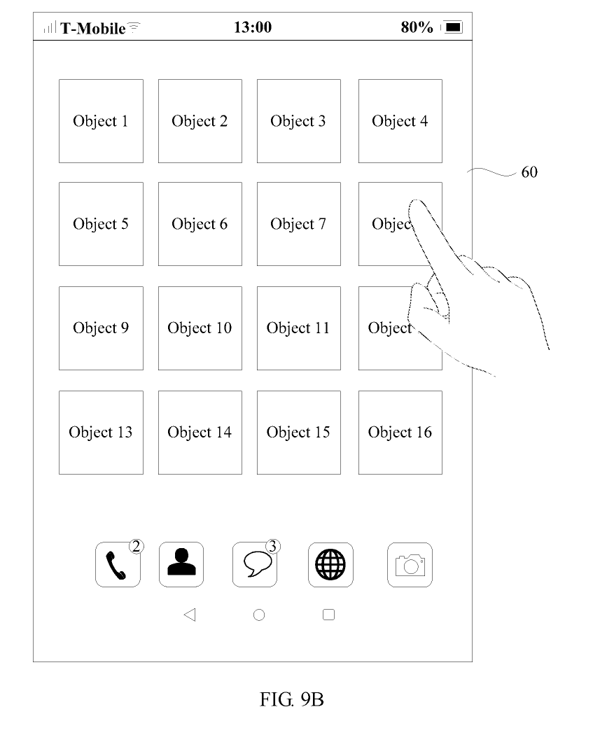

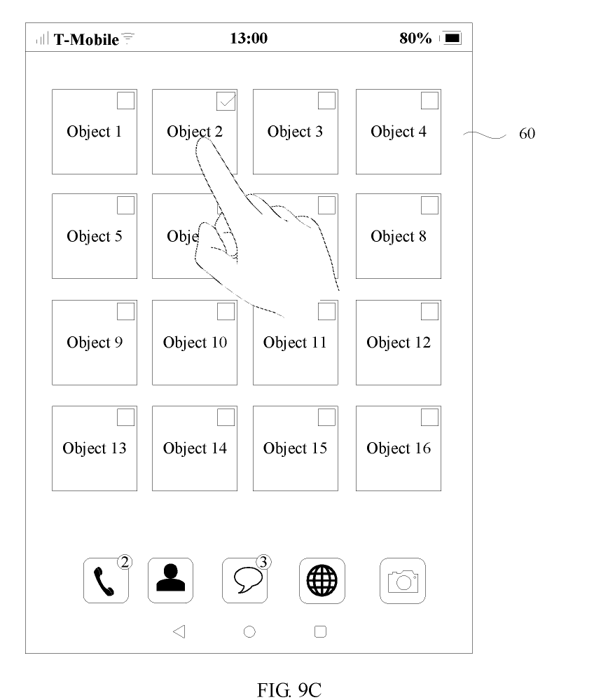

In some embodiments, the foregoing selection operation may be implemented in a selection mode. That is, before the foregoing selection operation is performed, the user inputs an operation instruction to enter the selection mode. As shown in FIG. 9A, the user may long press a blank space of a display screen, to enter the selection mode. As shown in FIG. 9B, the user may long press any object on a display screen, to enter the selection mode. Optionally, the user may alternatively tap a floating control on the display screen, to enter the selection mode. The display screen may alternatively set a menu option, so that the user may tap the menu option to enter the selection mode. In this embodiment of the present invention, a specific manner of entering the selection mode is not limited and can be flexibly set. Inputting a selection instruction in the selection mode can avoid an erroneous operation of the user.

As shown in FIG. 9C, after the display screen enters the selection mode, a checkbox may be set on an object on the display screen. The checkbox may be used to identify that a target object is selected, for example, select a checkbox of a target object 2. Alternatively, the checkbox of the target object may be made bold to identify a selected state.

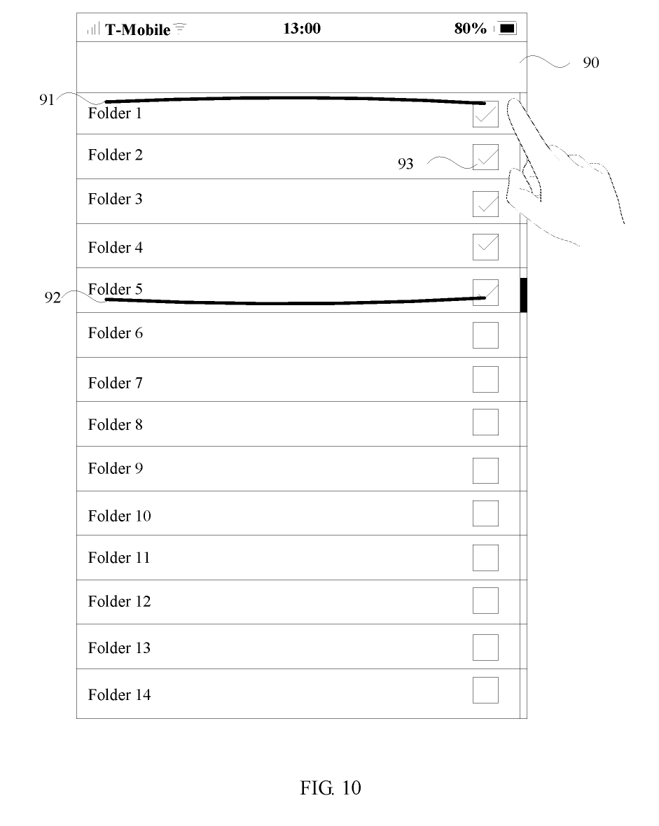

In some embodiments, the user may alternatively perform a multi-selection operation on entry objects according to a selection instruction. FIG. 10 shows a folder entry screen 90. The folder entry screen 90 displays folders 1 to 14. Each folder entry is corresponding to a checkbox 93. The checkbox 93 is used to identify whether a corresponding folder is selected. The user may perform a multi-selection operation by inputting a start selection instruction 91 and an end selection instruction 92. The processor 150 determines, based on the start selection instruction 91 and the end selection instruction 92, that target objects are the folders 1 to 5. Corresponding checkboxes of the target folders 1 to 5 may be identified as selected.

In the embodiments of the present invention, the terminal may set the selection mode. The following describes, by using examples, several manners of setting the selection mode.

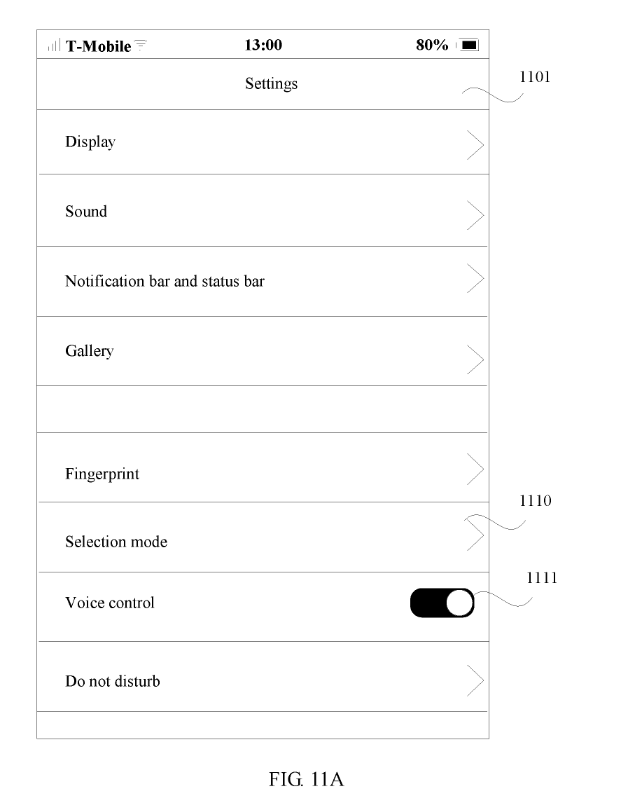

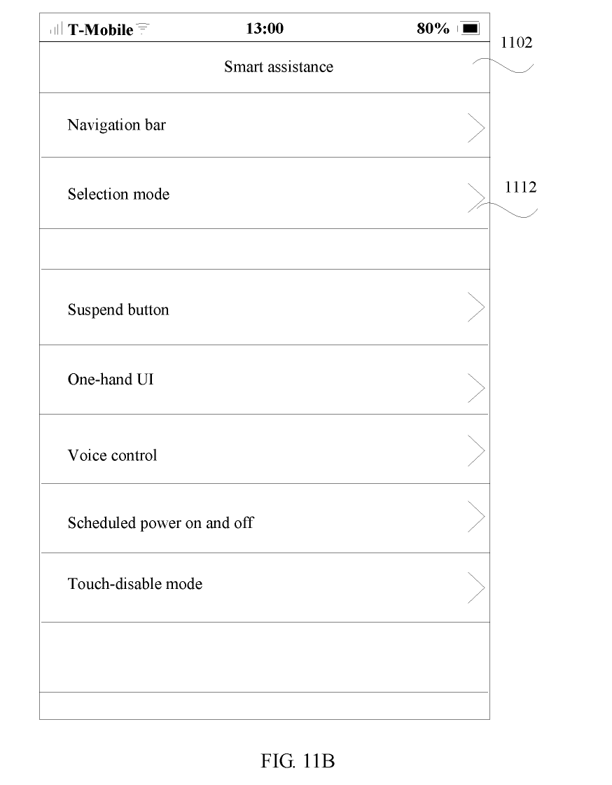

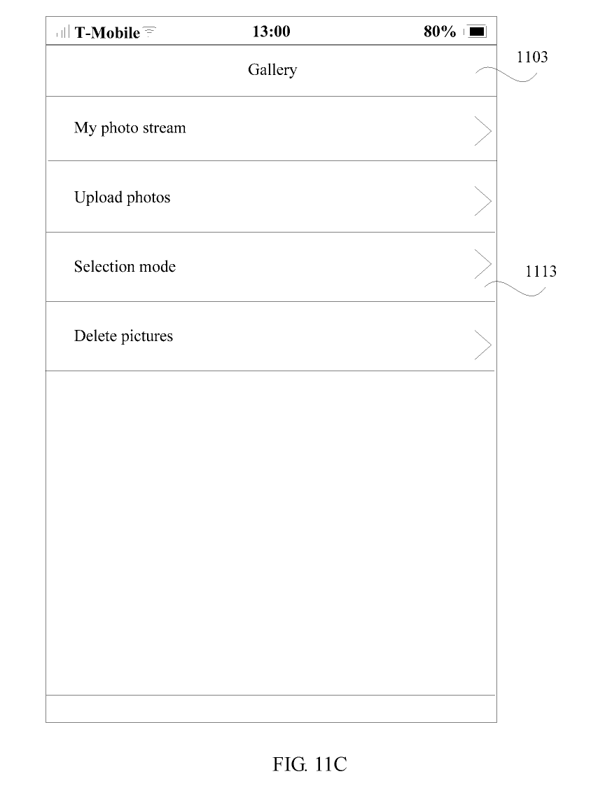

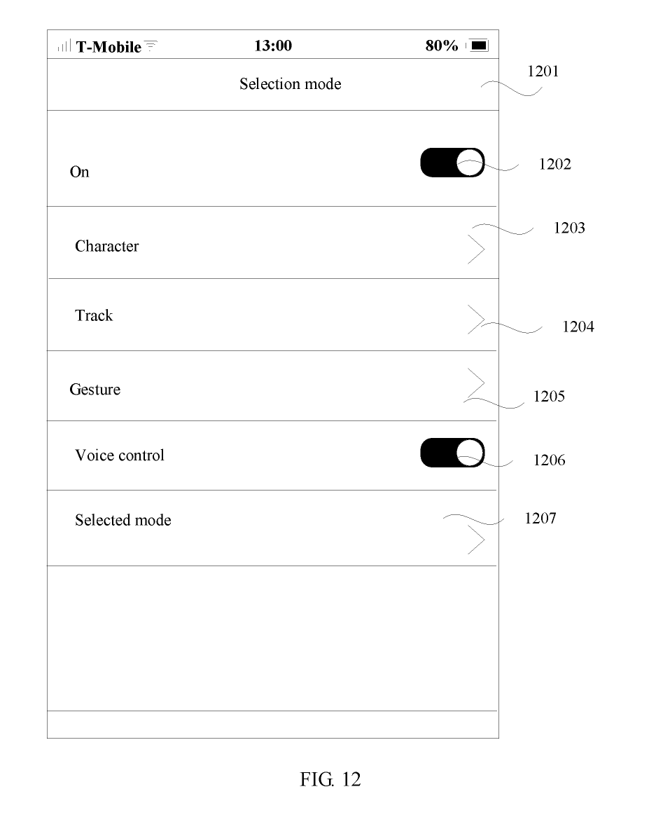

In some embodiments, the user may set the selection mode by using a setting screen of the terminal. The selection mode that is set by using the setting screen of the terminal may be applicable to all applications or screens of the terminal. As shown in FIG. 11A, on a setting screen 1101 of the terminal, a control option of a selection mode 1110 is set. The user may tap the control option of the selection mode 1110 to enter a selection mode control screen 1201 shown in FIG. 12.

In some embodiments, using a terminal running an Android system as an example, the user may set the selection mode by using a smart assistance control screen of the terminal running the Android system. As shown in FIG. 11B, on a smart assistance control screen 1102, a control option of a selection mode 1112 is set. The user may tap the control option of the selection mode 1112 to enter a selection mode control screen 1201 shown in FIG. 12.

In some embodiments, the user may set the selection mode by using an application setting screen. The selection mode that is set by using the application setting screen is applicable to the application. As shown in FIG. 11C, a gallery application is used as an example. The user may enter a setting screen 1103 of the gallery application by using a setting screen of the terminal. A control option of a selection mode 1113 may be set on the setting screen 1103 of the gallery application. The user may tap the control option of the selection mode 1113 to enter a selection mode control screen 1201 shown in FIG. 12.

In some embodiments, referring to FIG. 12, the selection mode control screen 1201 is described. On the selection mode control screen 1201, an enable button 1202 indicating that the selection mode function may be enabled or disabled may be set. When the selection mode function is enabled, it may indicate that a multi-selection mode is entered; or it may indicate that in the multi-selection mode, an instruction or a selected mode that is set is applicable. When the selection mode function is disabled, it may indicate that the multi-selection mode is not applicable, or a preset instruction or preset selected mode of the user is not applicable. When the selection mode is disabled, it is also likely that a default instruction or a default selected mode is applicable to the terminal 100. On the selection mode control screen 1201, one or more control options may be further set. The control option may be one or more of the following: a character 1203, a track 1204, a gesture 1205, a voice control 1206, and a selected mode 1207.

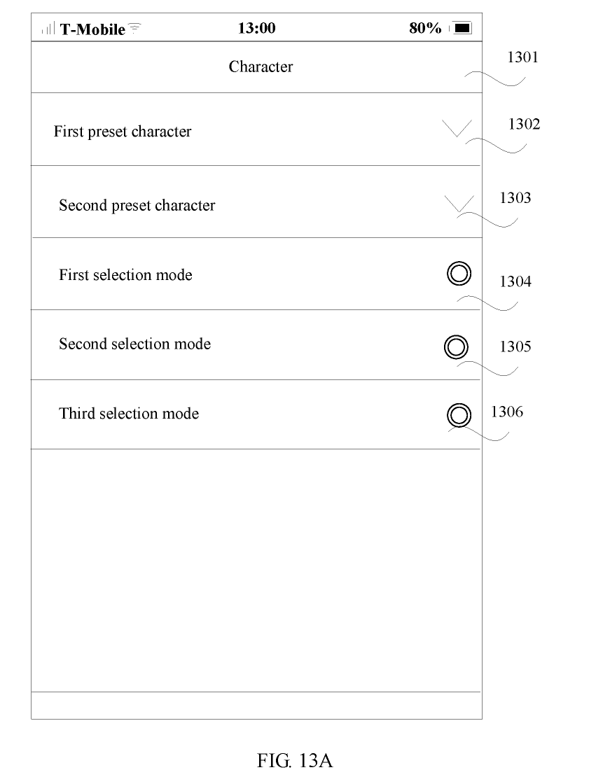

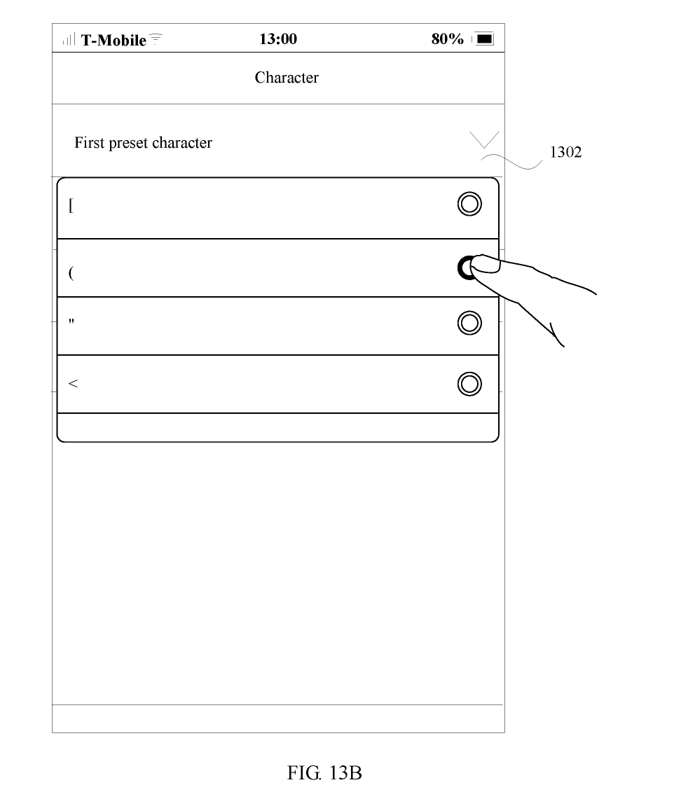

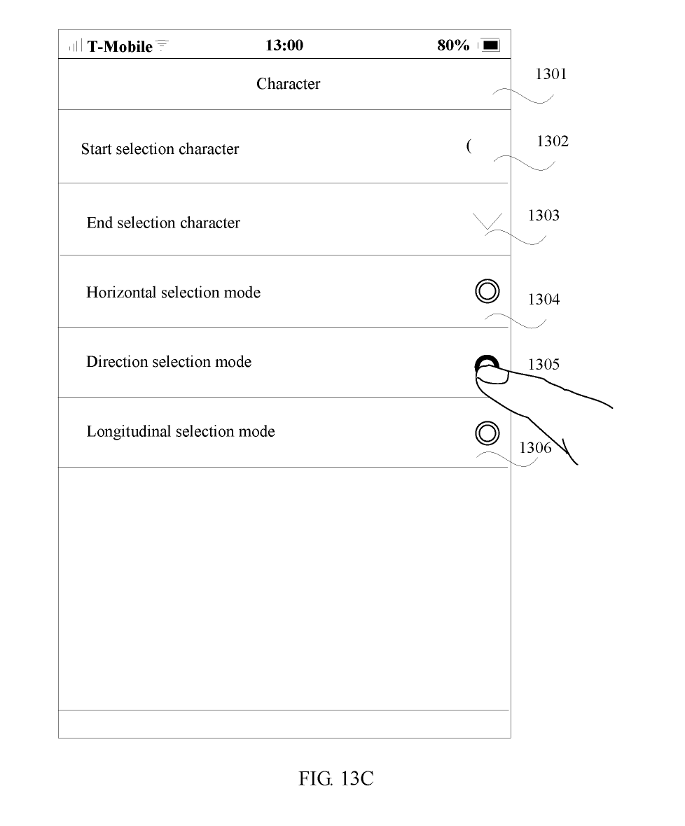

The character control option 1203 indicates that the user may set a particular character as the preset selection instruction. The user may tap the character control option 1203, to enter a character control screen 1301. As shown in FIG. 13A, the character control screen 1301 may include a first preset character option 1302 and a second preset character option 1303. The user may tap a drop-down box on the right side of the first preset character option 1302, to enter a corresponding character, as shown in FIG. 13B. As shown in FIG. 13B, the user taps a checkbox to select a character “(” as the start selection instruction. The character displayed in FIG. 13B is an example. In this embodiment of the present invention, a type of and a quantity of the characters are not limited. The character may be a common character, or may be an English letter. The user may select the character by using the drop-down box, or may input the character. The user may input the character by using a keyboard, a touch panel, or a voice. Inputting the second preset character option 1303 is similar to inputting the first preset character, and details are not described herein again.

In some embodiments, the first preset character option 1302 and the second preset character option 1303 may be specifically set as a start selection character option and an end selection character option respectively, as shown in FIG. 13C. Optionally, the user may set only the first preset character option 1302 or the second preset character option 1303.

In some embodiments, the first preset character option 1302 and the second preset character option 1303 each may be set as a start selection character option, indicating that a plurality of preset start selection instructions may be set. The first preset character option 1302 and the second preset character option 1303 each may be set as an end selection character option, indicating that a plurality of preset end selection instructions may be set.

In some embodiments, the user may set only a start selection character, or may set only an end selection character. The terminal may perform matching on a preset character and a selection operation that is input by the user, and flexibly use a selected mode to determine a target object. Determining the selected mode is similar to that in the foregoing embodiments, and details are not described herein again.

In some embodiments, as shown in FIG. 13A, the character control screen 1301 may further include a first selection mode option 1304, a second selection mode option 1305, and a third selection mode option 1306. The first selection mode may be specifically any selected mode, such as a horizontal selection mode, a longitudinal selection mode, a direction attribute mode, a unidirectional selection mode, or a closed image selection mode. The second selection mode and the third selection mode are similar to the first selection mode. The selected mode may be independently set for a character, or may be, as shown in the selection mode control screen 1201, set in the selection mode, that is, may be applicable in the selection mode. This is not only limited to the character, the gesture, or the track.

An application of the character control screen 1301 is described with reference to FIG. 13C. As shown in FIG. 13C, the first preset character option is specifically the start selection character option, and the second preset character option is specifically the end selection character option. The first selection mode option is specifically a horizontal selection mode option, the second selection mode option is specifically a direction selection mode option, and the third selection mode option is specifically a longitudinal selection mode option. It can be learned from FIG. 13C that the user specifies “(” as the preset start selection character, specifies no end selection character, and specifies the direction selection mode that is applicable to the start selection character. The user is allowed to set the preset selection instruction and the selected mode on the setting screen. This improves human-computer interaction efficiency and convenience of the terminal.

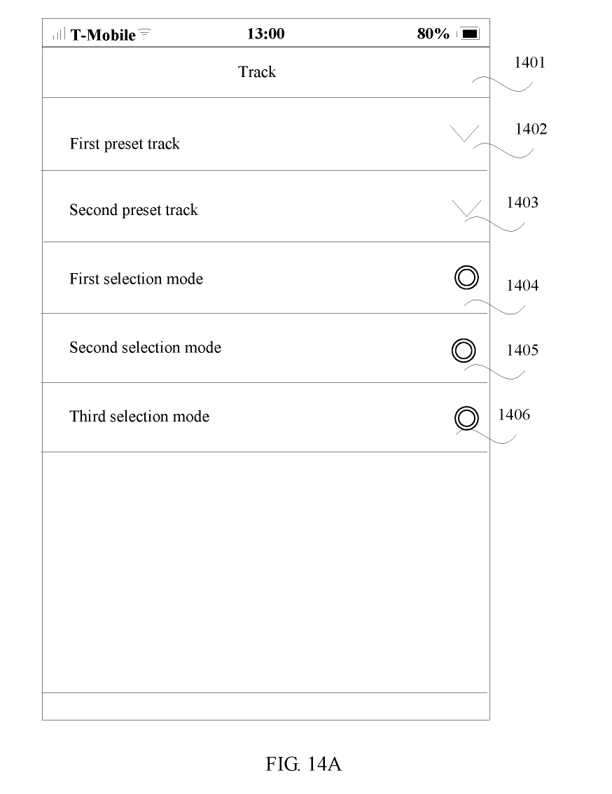

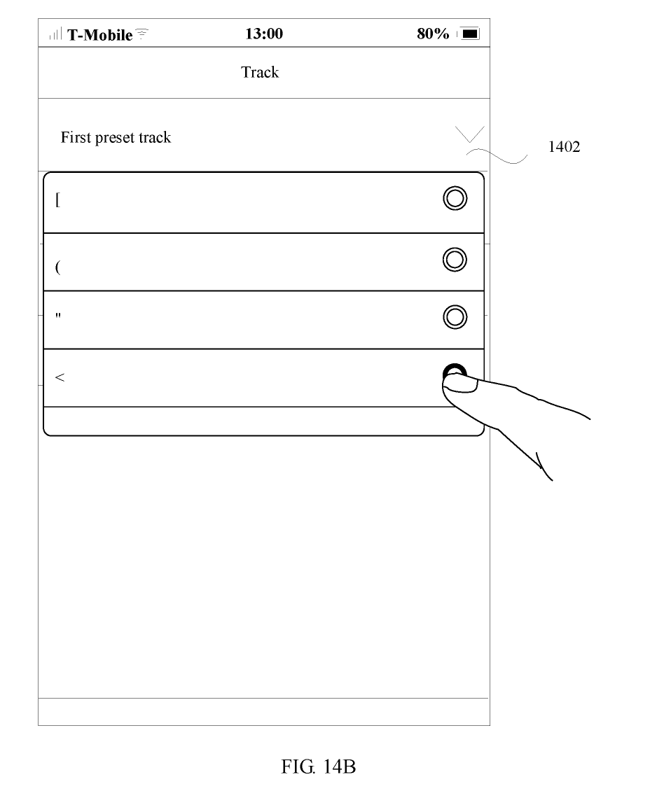

As shown in FIG. 12, the track control option 1204 indicates that the user may set a particular track as the preset selection instruction. The user may tap the track control option 1204, to enter a track control screen 1401. As shown in FIG. 14A, the track control screen 1401 may include at least one control option. For example, the control option includes a first preset track option 1402, a first preset track option 1403, a first selection mode option 1404, a second selection mode option 1405, and a third selection mode option 1406. As shown in FIG. 14B, the user may specify the preset selection instruction by using the track control screen. The user may alternatively input a preset track by using the touch panel 131. The first preset track may be set as a start selection track or an end selection track. The second preset track may be set as the start selection track or the end selection track. For a specific implementation, refer to the character control screen setting process. Details are not described herein again.

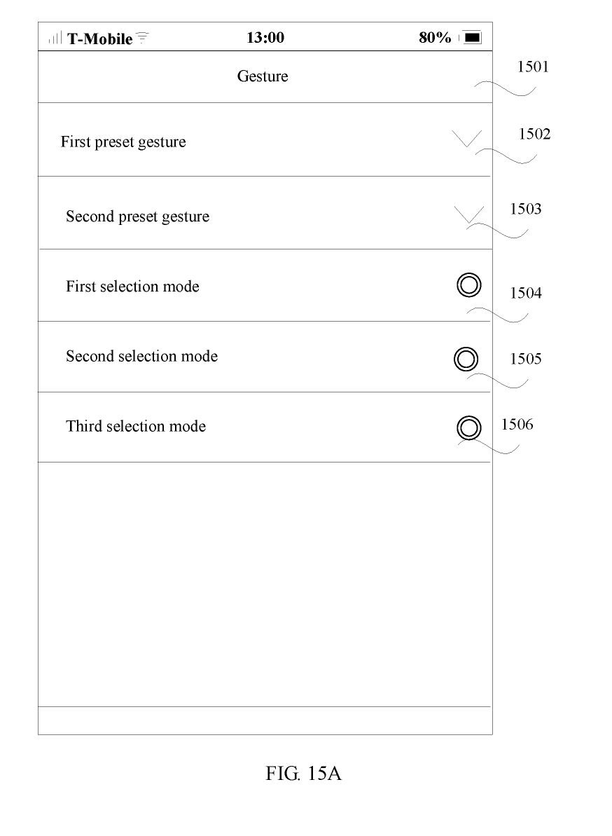

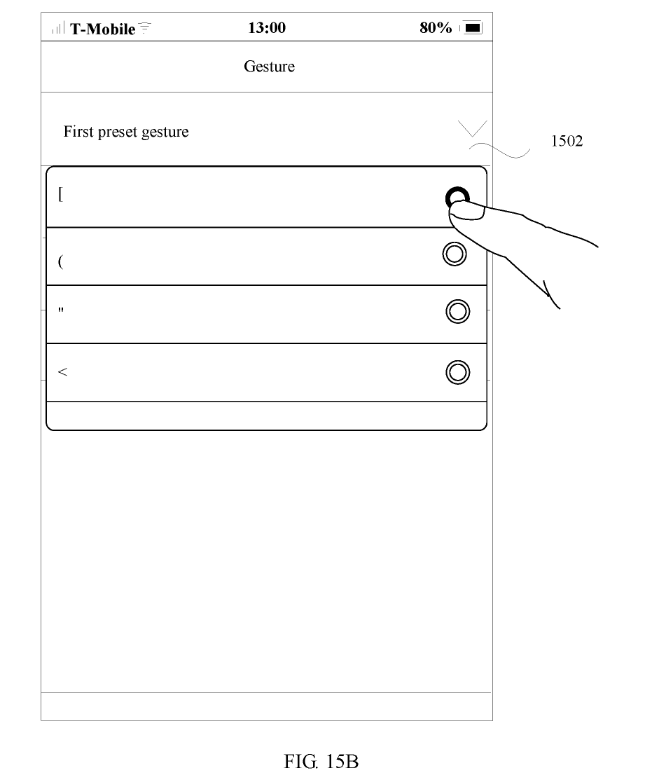

As shown in FIG. 12, the gesture control option 1205 indicates that the user may set a particular gesture as the preset selection instruction. The user may tap the gesture control option 1205, to enter a gesture control screen 1501. As shown in FIG. 15A, the gesture control screen 1501 may include at least one control option. For example, the control option includes a first preset gesture option 1502, a second preset gesture option 1503, a first selection mode option 1404, a second selection mode option 1405, and a third selection mode option 1406. As shown in FIG. 15B, the user may specify a preset gesture by using the gesture control screen. The user may alternatively input a preset gesture by using the light sensor 180. The user may alternatively input a particular track by using the touch panel 131, and set a gesture corresponding to the track as a preset gesture. The first preset gesture may be the start selection gesture or the end selection gesture. The second preset gesture may be the start selection gesture or the end selection gesture. The terminal may set both the first preset gesture and the second preset gesture as a start selection gesture. The terminal may alternatively set both the first preset gesture and the second preset gesture as an end selection gesture. The terminal may alternatively set the first preset gesture and the second preset gesture as the start selection gesture and the end selection gesture, respectively. For a specific implementation, refer to the character setting process. Details are not described herein again.

As shown in FIG. 12, the voice control option 1206 indicates that the user may set to use a voice to control a selection instruction. The voice control option 1206 may be enabled or disabled. When the voice control option 1206 is enabled, the terminal may recognize a voice control of the user to perform a selection operation. The voice control option 1206 may be set on a selection mode setting screen, to indicate that the voice control is applicable to a multi-selection operation. The voice control function may alternatively be set on a terminal setting screen, for example, a voice control option 1111 shown in FIG. 11A. The voice control option 1111 enabled indicates that the voice control is applicable to all operations of the terminal, including a multi-selection operation. The user may input voice “Enter the multi-selection mode” by using the microphone 162, to control the terminal to switch from the current display screen to the multi-selection mode. The processor 150 parses a voice signal of “Enter the multi-selection mode”, and controls switching of the current display screen. The user may alternatively input voice “Select all objects” by using the microphone 162, to select all objects on the current display screen or all objects in the current folder. The user may alternatively input voice “Select all objects on the current display screen” to select all the objects on the current display screen. The user may alternatively use voice “Select objects 1 to 5” to select the objects 1 to 5 on the current display screen. The user implements voice input by using the microphone 162, and the processor 150 parses the voice input that is received by the microphone 162 and controls object selection of the terminal. In this embodiment of the present invention, a specific voice control manner is not limited.

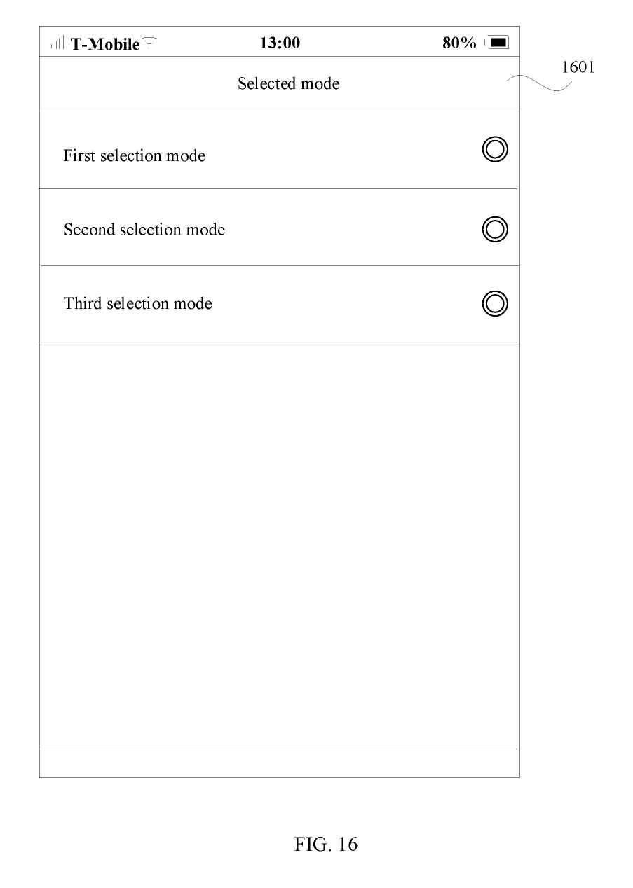

As shown in FIG. 12, the selected-mode control option 1207 indicates that the user may set the selected mode on the selection mode control screen. The selected mode that is set on the selection mode control screen is applicable to a selection operation in the multi-selection mode. The user may tap the selected-mode control option 1207 to enter a selected-mode control screen 1601 shown in FIG. 16. The selected-mode control screen 1601 may include at least one selection mode, for example, a first selection mode 1602. That the selected-mode control screen 1601 in FIG. 16 includes the first selection mode 1602, a second selection mode 1603, and a third selection mode 1604 is for illustrative purposes. For specific settings and applicability of the selection mode, refer to the foregoing related descriptions of the character control screen 1301 and FIG. 13C. Details are not described herein again.

In an implementation process, the foregoing methods can be implemented by using a hardware integrated logical circuit in the processor, or by using instructions in a form of software. The methods disclosed with reference to the embodiments of the present invention may be directly executed and completed by using a hardware processor, or may be executed and completed by using a combination of hardware and software modules in the processor. The software module may be located in a mature storage medium in the field, such as a random access memory, a flash memory, a read-only memory, a programmable read-only memory, an electrically-erasable programmable memory, or a register. The storage medium is located in the memory, and a processor executes an instruction in the memory and completes the steps in the foregoing methods in combination with hardware of the processor. To avoid repetition, details are not described herein.

A person of ordinary skill in the art may be aware that, in combination with the examples described in the embodiments disclosed in this specification, method steps and units may be implemented by electronic hardware, computer software, or a combination thereof. To clearly describe the interchangeability between the hardware and the software, the foregoing has generally described steps and compositions of each embodiment based on functions. Whether the functions are performed by hardware or software depends on particular applications and design constraint conditions of the technical solutions. A person of ordinary skill in the art may use different methods to implement the described functions for each particular application, but it should not be considered that the implementation goes beyond the scope of the embodiments of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed terminal and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. A part or all of the units may be selected depending on actual needs to achieve the objectives of the solutions of the embodiments of the present invention.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions in the embodiments of the present invention essentially, or the part contributing to the prior art, or all or some of the technical solutions may be implemented in the form of a software product. The software product is stored in a storage medium and includes several instructions for instructing a computer device (which may be a personal computer, a server, a network device, or the like) to perform all or some of the steps of the methods described in the embodiments of the present invention. The foregoing storage medium includes any medium that can store program code, such as a USB flash drive, a removable hard disk, a read-only memory (Read-Only Memory, “ROM” for short), a random access memory (Random Access Memory, “RAM” for short), a magnetic disk, or an optical disc.

In the foregoing specific implementations, the objective, technical solutions, and benefits of the present invention are further described in detail. It should be understood that different embodiments can be combined. The foregoing descriptions are merely specific implementations of the present invention, but are not intended to limit the protection scope of the present invention. Any combination, modification, equivalent replacement, or improvement made without departing from the spirit and principle of the present invention should fall within the protection scope of the present invention.

What is claimed is:

1. An object processing method, wherein the method comprises:
displaying a first display screen, wherein the first display screen comprises at least two objects;
receiving a first operation instruction;
entering a selection mode according to the first operation instruction;
receiving a first selection instruction in the selection mode;
determining a first position according to the first selection instruction;
receiving a second selection instruction;
determining a second position according to the second selection instruction; and
determining an object between the first position and the second position as a first target object.

2. The method according to claim 1, wherein the receiving a first selection instruction includes receiving the first selection instruction on the first display screen, and the determining a first position according to the first selection instruction includes determining the first position on the first display screen;
before the receiving a second selection instruction, the method further comprises:
receiving a display screen switch operation instruction; and
switching to a second display screen; and
wherein the receiving a second selection instruction includes receiving the second selection instruction on the second display screen, and the determining a second position according to the second selection instruction includes determining the second position on the second display screen.

3. The method according to claim 1, wherein the method further comprises:
receiving a third selection instruction and a fourth selection instruction;
determining a third position and a fourth position according to the third selection instruction and the fourth selection instruction;
determining an object between the third position and the fourth position as a second target object; and
marking both the first target object and the second target object as being in a selected state.

4. The method according to claim 1, wherein the determining a first position according to the first selection instruction includes:
performing matching on the first selection instruction and a first preset instruction; and
when the matching on the first selection instruction and the first preset instruction succeeds:
determining that the first selection instruction is a selection instruction; and
determining a position corresponding to the first selection instruction as the first position; and
the determining a second position according to the second selection instruction includes:
performing matching on the second selection instruction and a second preset instruction; and
when the matching on the second selection instruction and the second preset instruction succeeds:
determining that the second selection instruction is a selection instruction; and
determining a position corresponding to the second selection instruction as the second position.

5. The method according to claim 3, wherein the determining a third position according to the third selection instruction includes:
performing matching on the third selection instruction and a first preset instruction; and
when the matching on the third selection instruction and the first preset instruction succeeds:
determining that the third selection instruction is a selection instruction; and
determining a position corresponding to the third selection instruction as the third position; and
the determining a fourth position according to the fourth selection instruction includes:
performing matching on the fourth selection instruction and a second preset instruction; and
when the matching on the fourth selection instruction and the second preset instruction succeeds;
determining that the fourth selection instruction is a selection instruction; and
determining a position corresponding to the fourth selection instruction as the fourth position.

6. The method according to claim 1, wherein the first selection instruction is a first track/gesture, and the determining a first position according to the first selection instruction includes:
performing matching on the first track/gesture and a first preset track/gesture; and
when the matching on the first track/gesture and the first preset track/gesture succeeds:
determining that the first track/gesture is a selection instruction; and
determining a position corresponding to the first track/gesture as the first position; and
wherein the second selection instruction is a second track/gesture, and the determining a second position according to the second selection instruction includes:
performing matching on the second track/gesture and a second preset track/gesture; and
when the matching on the second track/gesture and the second preset track/gesture succeeds;
determining that the second track/gesture is a selection instruction; and
determining a position corresponding to the second track/gesture as the second position.

7. The method according to claim 1, wherein the first selection instruction is a first track/gesture, and the determining a first position according to the first selection instruction includes:
recognizing the first track/gesture as a first character;
performing matching on the first character and a first preset character; and
when the matching on the first character and the first preset character succeeds:
determining that the first character is a selection instruction; and
determining a position corresponding to the first character as the first position; and
wherein the second selection instruction is a second track/gesture, and the determining a second position according to the second selection instruction includes:
recognizing the second track/gesture as a second character;
performing matching on the second character and a second preset character; and
when the matching succeeds:
determining that the second character is a selection instruction; and
determining a position corresponding to the second character as the second position.

8. The method according to claim 1, wherein the method further comprises: marking the first target object as being in a selected state; and
the marking the first target object as being in the selected state includes:
marking, according to the first selection instruction, an object after the first position as being selected; and
canceling selected-identification of an object outside the first position and the second position according to the second selection instruction.

9. The method according to claim 1, wherein the determining an object between the first position and the second position as a first target object includes: determining the object between the first position and the second position as the first target object using a selected mode.

10-14. (canceled)

15. The method according to claim 1, wherein the first operation instruction is a voice control instruction, and the entering a selection mode according to the first operation instruction includes: entering the selection mode according to the voice control instruction.

16. The method according to claim 1, wherein at least one of the first selection instruction or the second selection instruction is a voice selection instruction.

17. An object processing terminal, wherein the terminal comprises: a display, an input, and at least one processor, wherein:
the display is configured to display a first display screen comprising at least two objects;
the input is configured to receive a first operation instruction; and
the at least one processor is configured to determine, according to the first operation instruction, to enter a selection mode, wherein:
in the selection mode, the input is further configured to receive a first selection instruction and a second selection instruction; and
the at least one processor is further configured to:
determine a first position according to the first selection instruction;
determine a second position according to the second selection instruction; and
determine an object between the first position and the second position as a target object.

18. The terminal according to claim 17, wherein the input is further configured to receive the first selection instruction on the first display screen;
the at least one processor is further configured to determine the first position on the first display screen;
the input is further configured to receive a display screen switch operation instruction, wherein the display screen switch operation instruction is used to instruct to switch to a second display screen;
the display is further configured to display the second display screen;
the input is further configured to receive the second selection instruction on the second display screen; and
the at least one processor is further configured to determine the second position on the second display screen.

19. The terminal according to claim 17, wherein the input is further configured to receive a third selection instruction and a fourth selection instruction, and the at least one processor is further configured to:
determine a third position and a fourth position according to the third selection instruction and the fourth selection instruction;
determine an object between the third position and the fourth position as a second target object; and
mark both the first target object and the second target object as being in a selected state.

20. The terminal according to claim 17, wherein the at least one processor is further configured to:
perform matching on the first selection instruction and a first preset instruction;
when the matching on the first selection instruction and the first preset instruction succeeds:
determine that the first selection instruction is a selection instruction; and
determine a position corresponding to the first selection instruction as the first position;
perform matching on the second selection instruction and a second preset instruction; and
when the matching on the second selection instruction and the second preset instruction succeeds:
determine that the second selection instruction is a selection instruction; and
determine a position corresponding to the second selection instruction as the second position.

21. The terminal according to claim 19, wherein the at least one processor is further configured to:
perform matching on the third selection instruction and a first preset instruction; and
when the matching on the third selection instruction and the first preset instruction succeeds:
determine that the third selection instruction is a selection instruction; and
determine a position corresponding to the third selection instruction as the third position; and
the at least one processor is further configured to:
perform matching on the fourth selection instruction and a second preset instruction; and
when the matching on the fourth selection instruction and the second preset instruction succeeds;
determine that the fourth selection instruction is a selection instruction; and
determine a position corresponding to the fourth selection instruction as the fourth position.

22. The terminal according to claim 17, wherein the first selection instruction is a first track/gesture, the second selection instruction is a second track/gesture, and
the at least one processor is further configured to:
perform matching on the first track/gesture and a first preset track/gesture;
when the matching on the first track/gesture and the first preset track/gesture succeeds:
determine that the first track/gesture is a selection instruction; and
determine a position corresponding to the first track/gesture as the first position;
perform matching on the second track/gesture and a second preset track/gesture; and
when the matching on the second track/gesture and the second preset track/gesture succeeds:
determine that the second track/gesture is a selection instruction; and
determine a position corresponding to the second track/gesture as the second position.

23. The terminal according to claim 17, wherein the first selection instruction is a first track/gesture, the second selection instruction is a second track/gesture, and
the at least one processor is further configured to:
recognize the first track/gesture as a first character;
perform matching on the first character and a first preset character;
when the matching on the first character and the first preset character succeeds:
determine that the first character is a selection instruction; and
determine a position corresponding to the first character as the first position;
recognize the second track/gesture as a second character;
perform matching on the second character and a second preset character; and
when the matching on the second character and the second preset character succeeds:
determine that the second character is a selection instruction; and
determine a position corresponding to the second character as the second position.

24-27. (canceled)

28. The terminal according to claim 17, wherein the at least one processor is further configured to determine the object between the first position and the second position as the target object using a selected mode, wherein the selected mode is at least one of the following modes: a horizontal selection mode, a longitudinal selection mode, a direction attribute mode, a unidirectional selection mode, or a closed image selection mode.

29. The terminal according to claim 17, wherein the input further comprises a microphone, wherein the microphone is configured to receive at least one of the first selection instruction or the second selection instruction, and the at least one of the first selection instruction or the second selection instruction is a voice selection instruction.
